(19) United States
(12) Patent Application Publication
(10) Pub. No.: US 2022/0318828 A1
(43) Pub. Date: Oct. 6, 2022

(54) SYSTEM AND METHOD FOR HIGHLIGHT DETECTION

(71) Applicant: 17LIVE Japan Inc., Tokyo (JP)

(72) Inventors: Yungchi HSU, Taipei City (TW); Yihsiung CHEN, Taipei City (TW); Mohammad AMIR, Taipei City (TW); Rishabh CHANANA, Taipei City (TW); Anmol MOHAN, Taipei City (TW); Yuchuan CHANG, Taipei City (TW); Yuchun CHEN, Taipei City (TW); Min-Yan HSIEH, Taipei City (TW)

(21) Appl. No.: 17/708,171

(22) Filed: Mar. 30, 2022

Related U.S. Application Data
(63) Continuation-in-part of application No. PCT/US2021/024808, filed on Mar. 30, 2021.
Application No. PCT/US2021/024808 is a continuation-in-part of application No. PCT/US2021/024810, filed on Mar. 30, 2021.
Application No. PCT/US2021/024810 is a continuation-in-part of application No. PCT/US2021/039815, filed on Jun. 30, 2021.

(51) Int. Cl. G06Q 30/02

(52) U.S. Cl. CPC G06Q 30/0201

(57) ABSTRACT

The present application relates to a system and method for highlight detection, and includes a highlight detection method for detecting highlights of a stream. The method comprises: collecting purchasing information from a user terminal; and detecting the highlight of the stream according to the purchasing information. The purchasing information includes purchasing actions of the user terminal, and the purchasing actions are actions related to purchase of the user terminal. According to the subject application, the highlights may be detected, captured and generated automatically, and the time and efforts for manual work may be saved.

### CROSS-REFERENCE TO RELATED APPLICATIONS

This application claims priority under 35 U.S.C. § 111(a) and is a continuation-in-part of International Patent Application No. PCT/US2021/024808, filed on 30 Mar. 2021, is a continuation-in-part of International Patent Application No. PCT/US2021/024810, filed on 30 Mar. 2021, and is a continuation-in-part of International Patent Application No. PCT/US2021/039815, filed on 30 Jun. 2021. The disclosures of each of the previously listed applications are incorporated herein by reference in their entireties.

### FIELD

This disclosure relates to information and communication technology, and in particular, to a system and a method for messages distribution.

This disclosure also relates to information and communication technology, and in particular, to a system and a method for data communication.

This disclosure additionally relates to information and communication technology, and in particular, to a system and a method for highlight detection.

### BACKGROUND

With vigorous development of the Internet and mobile networks, electronic products (such as a mobile phone, a tablet computer, a desktop computer, a notebook, and a smart appliance) having a network access function have been widely used by the public. In addition, information is massive on networks and can be conveniently obtained. In order to attract people's attention, some APPs or platforms always distribute messages to user terminals by pushing notifications.

Current push notifications are sent automatically or manually to bring back users to the platform and build/increase their affinity towards the platform. The current System is not personalized, and it is limited to the streamers that the user follows, the high performing streamers, or offers/promotions.

However, notifications with inappropriate content at the wrong time does not attract people's attention at all, sometimes it makes the user feel annoyed. Therefore, personalized notifications with appropriate contents at an appropriate time is a very important issue.

Technologies for enabling users to have and participate in mutual on-line communication are known. Communication protocols are necessary for users to transmit and receive data via the internet. With vigorous development of communication technology, real-time communication such as video call and live streaming is in great demand.

There are a lot of communication protocols for real-time communication. With different communication protocols, the advantages and disadvantages are all different. Some communication protocols are good for real-time interactions with low latency while some communication protocols guarantee the smoothness of the streaming.

Different communication protocols are requested in different scenarios. For example, for the users who want to have real-time interaction such as playing interactive games, the communication protocols with low latency are necessary. If the communication protocols are not appropriate, it might cause any sort of user dissatisfaction. Therefore, it is a very important issue to communicate via appropriate communication protocols in response to different scenarios.

In order to catch the viewer's eyes, the streamers are broadcasting online to interact with the viewers. The live streaming may be applied in a variety of scenarios such as entertainment shows, online shopping events or the like. Even if the viewers missed the live streams, the streams may be replayed to watch again.

However, the live stream video is always long and mixed with the contents which are not interesting or attractive. The viewers would not be patient to watch all of the video. Although the streamer may clip the highlight for the viewers manually, it takes time and effort to capture the highlights from the video. Therefore, an efficient way to generate highlights automatically is an important issue.

### SUMMARY

An embodiment of the present application relates to a message distribution system, including a collecting unit and an evaluating unit. The collecting unit is configured to collect feedback on a message from a user terminal. The evaluating unit is connected to the collecting unit, and is configured to evaluate a preference for the message of the user terminal according to the feedback. The feedback includes a response action feedback and/or an influence action feedback. The response action feedback includes an operation to the message by the user terminal. The influence action feedback includes a behavior followed by the operation.

Another embodiment of subject application relates to a message distribution method, including: collecting feedback on a message from a user terminal; and evaluating a preference for the message of the user terminal according to the feedback. The feedback includes a response action feedback and an influence action feedback. The response action feedback includes an operation to the message by the user terminal. The influence action feedback includes a behavior followed by the operation.

The present application increases the discoverability of the content that users are looking for, and further improves the satisfaction of the message to the user and optimizes the user experience.

Another embodiment of the present application relates to a data communication system, comprising: a receiving unit, configured to receive an action performed by an user terminal; and a determining unit, connected to the receiving unit and configured to determine a communication protocol toward the user terminal according to the action. The communication protocol is transferred to the user terminal for the user terminal to request real-time data via the communication protocol.

Yet another embodiment of the present application relates to a data communication method, comprising: receiving an action performed by an user terminal; and determining a communication protocol toward the user terminal according to the action. The communication protocol is transferred to the user terminal for the user terminal to request real-time data via the communication protocol.

The present application switches different communication protocols while the user terminal takes different action in different scenarios. Therefore, the satisfaction for the user to watch the live streaming is improved and the user experience is also optimized.

Still yet another embodiment of the present application relates to a highlight detection method for detecting highlight of a stream, comprising: collecting purchasing information from a user terminal; and detecting the highlight of the stream according to the purchasing information; wherein the purchasing information includes purchasing actions of the user terminal, and the purchasing actions are actions related to purchase of the user terminal.

Still further, another embodiment of the present application relates to a highlight detection system for detecting highlight of a stream, comprising: a highlight detection unit, configured to collect purchasing information from a user terminal, and detect the highlight of the stream according to the purchasing information; wherein the purchasing information includes purchasing actions of the user terminal, and the purchasing actions are actions related to purchase of the user terminal.

According to the present application, the highlights may be detected, captured and generated automatically, and the time and efforts for manual work may be saved.

### BRIEF DESCRIPTION OF THE DRAWINGS

FIG. 1 is a schematic configuration of a communication system 1 according to some embodiments of the present application;

FIG. 2 is a schematic block diagram of the message distribution system 100 according to some embodiments of the present application;

FIG. 3 is a schematic configuration of a communication system 1′ according to some embodiments of the present application;

FIG. 4 is a schematic block diagram of the message distribution system 100′ according to some embodiments of the present application;

FIG. 5 is a schematic block diagram of the preference evaluating element 124 according to some embodiments of the present application;

FIG. 6 is a schematic configuration of a communication system 600 according to some embodiments of the present application;

FIG. 7 is a schematic block diagram of the data communication system 700 according to some embodiments of subject application;

FIG. 8A is an exemplary functional configuration of the action A;

FIG. 8B is an exemplary functional configuration of the action A;

FIG. 9A is an exemplary functional configuration of the action A;

FIG. 9B is an exemplary functional configuration of the action A;

FIG. 10 is an exemplary functional configuration of the action A;

FIG. 11 is an exemplary sequence chart illustrating an operation of communication system 600 and data communication system 700;

FIG. 12 is a schematic configuration of a communication system according to some embodiments of subject application;

FIG. 13 is a schematic block diagram illustrating a communication system, a highlight detection system and a highlight detection unit according to some embodiments of subject application;

FIG. 14 is an exemplary functional configuration of the highlight detection unit;

FIG. 15 is an exemplary functional configuration of the highlight detection unit;

FIG. 16 is an exemplary functional configuration of the highlight detection unit;

FIG. 17 is an exemplary functional configuration of the highlight detection unit;

FIG. 18 is an exemplary functional configuration of the highlight detection unit;

FIG. 19 is an exemplary functional configuration of the highlight detection unit;

FIG. 20 is an exemplary functional configuration of the highlight detection unit;

FIG. 21 shows an exemplary sequence chart illustrating an operation of a highlight detection method performed by a highlight detection unit according to some embodiments of subject application.

### DETAILED DESCRIPTION

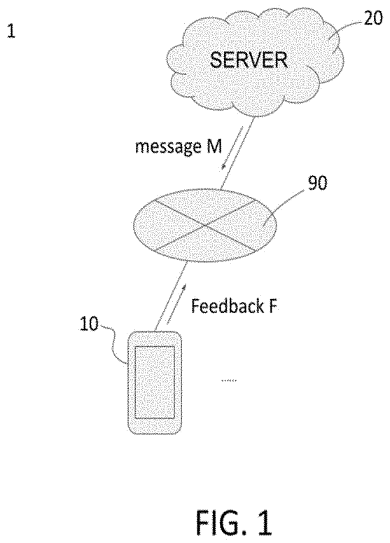

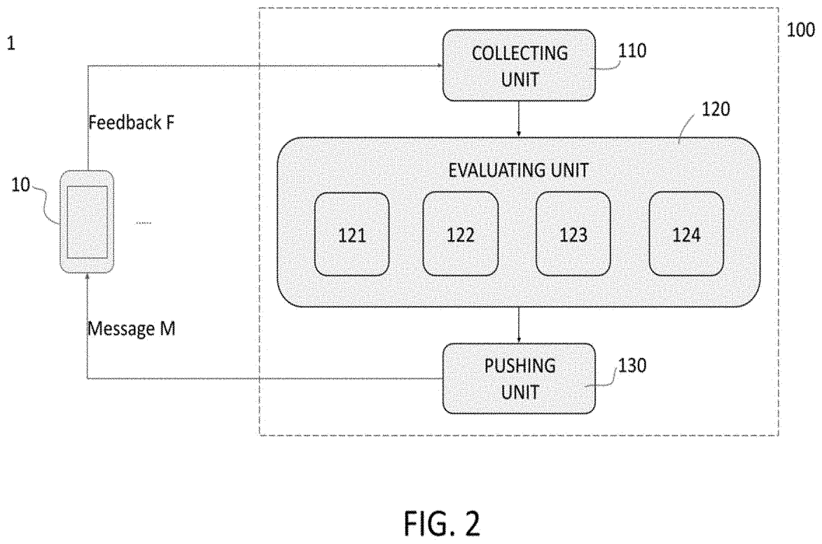

FIG. 1 is a schematic configuration of a communication system 1 according to some embodiments of subject application. The communication system 1 includes a user terminal 10 and a server 20. The user terminals 10 and the server 20 are connected via a network 90, which is the Internet, for example. Server 20 includes a message distribution system 100. The message distribution system 100 is configured to send a message M to the user terminal 10 and receive feedback F on the message M from the user terminal 10. In some embodiments, message M may be text message, mail, chat bubble, push message, push notification, and the like. In some embodiments, contents of the message M may be text, picture, sound, audio, video, live streaming, podcasting, sales, and the like. In some embodiments, the user terminal 10 may be a device a user uses. The device may be electronic products. The user may be referred to as a viewer, streamer, podcaster, audience, listener or the like. The communication system 1 may include a plurality of user terminals 10, and the user terminal 10 are shown in FIG. 1 and FIG. 2 for simplification.

FIG. 2 is a schematic block diagram of the message distribution system 100 according to some embodiments of subject application. The message distribution system 100 includes a collecting unit 110, an evaluating unit 120 and a pushing unit 130. The collecting unit 110 is configured to collect a feedback F on a message M from a user terminal 10. The evaluating unit 120 is connected to the collecting unit 110 and configured to evaluate a preference P for the message M of the user terminal 10 according to the feedback F. The pushing unit 130 is connected to the evaluating unit 120 and configured to push the message M to the user terminal 10.

As shown in FIG. 2, the pushing unit 130 pushes a message M to the user terminal 10 and the collecting unit 110 collects the feedback F on the message M from the user terminal 10. The collecting unit 110 transmits the feedback F on the message M to the evaluating unit 120 and the evaluating unit 120 evaluates a preference P for the message M of the user terminal 10 according to the feedback F. Then, the pushing unit 130 receives the preference P from the evaluating unit 120. If the user terminal 10 has the preference P for the message M, the pushing unit 130 pushes the message M to the user terminal 10. On the other hand, if the user terminal 10 has no preference P for the message M, the pushing unit 130 stops pushing the message M to the user terminal 10.

The feedback F may refer to an action the user terminal 10 takes against the message M. In some embodiments, the feedback F may include a response action feedback Fr and an influence action feedback Fi. The response action feedback Fr may refer to an operation to the message M operated by the user terminal 10. The influence action feedback Fi may refer to a behavior followed by the operation. Once the user terminal 10 took actions against the message M, the user terminal 10 transmits data to the message distribution system 100. Different data corresponds to different types of action. The evaluating unit 120 evaluates the preference P for the message M according to different types of data.

In some embodiments, the operation may include clicking, swiping, deleting, ignoring, silencing, turning off notifications, expanding, minimizing, or other operations the user terminal 10 may operate to the message M, and the combination of above. For example, the operation may include clicking the message M or swiping to delete the message M. In some embodiments, the operation may also include ignoring the message M, turning off the pushing notification function of the device, or unsubscribing the push notification of the message M or the like. In some embodiments, the message M may be expanded from a simplified message M to a full message M. The operation may further include expanding and clicking the message M, expanding and swiping to delete the message M and so on.

In some embodiments, the evaluating unit 120 evaluates the preference P of the user terminal 10 according to the operation. For example, if the user terminal 10 operates the message M and opens the APP, it shows that the user terminal 10 has the preference P for the message M. On the other hand, if the user terminal 10 operates the message but does not open the APP, it shows that the user terminal 10 has no preference P for the message M. For example, the evaluating unit 120 evaluates that the user terminal 10 has a preference P for the message M if the user terminal 10 clicks the message M, and evaluates that the user terminal 10 has no preference P for the message M if the user terminal 10 swipes to delete the message M. Once the user terminal 10 operates the message M with an operation, the user terminal 10 transmits data to the message distribution system 100. Different data corresponds to different types of operation. The evaluating unit 120 evaluates the preference P for the message M according to different types of data.

In some embodiments, the preference P may include the preference P for the simplified message M and the preference P for the full message M. For example, if the user terminal 10 expands the simplified message M to a full message M and clicks the message M, it shows that the user terminal 10 has the preference P for both the simplified and full message M. On the other hand, if the user terminal 10 expands the simplified message M to a full message M but does not click the message M, it shows that the user terminal 10 has the preference P for the simplified message M but has no preference for the full message M. If the user terminal 10 neither expands nor clicks the message M, it shows that the user terminal 10 has no preference P for the simplified message M and the full message M at all.

In some embodiments, the behavior may include being idle, searching, visiting, following, purchasing, sending, watching, commenting, supporting, marking, collecting, claiming, or the action the user may perform in the APP, and the combination of above. In other words, the behavior may be an action the user terminal 10 takes or a state the user terminal 10 is in after operating the message M. For example, the user terminal 10 may be idle at the front page for a moment and close the app. In some embodiments, the user terminal 10 may search for streamers or events, or visiting streamer's profile or explore sections. In some embodiments, the user terminal 10 may enter a live room and chat with the streamer, or send gifts to the streamer. In some embodiments, the user terminal 10 may comment on articles or events. In some embodiments, the user terminal 10 may purchase gifts, points or membership in the online store. In some embodiments, the user terminal 10 may follow specific streamers, support a streamer, or marking the user as loyal fans or favorite streamers and so on.

In some embodiments, the evaluating unit 120 evaluates the preference P of the user terminal 10 according to the behavior. if the user terminal 10 spends time and takes some actions in the app, it shows that the user terminal 10 has a preference P for the message M. On the other hand, if the user terminal 10 is being idle without doing anything and closes the app, it shows that the user terminal 10 has no preference P for the message M. For example, if the user terminal 10 opens the APP and searches for a streamer, the evaluating unit 120 evaluates that the user terminal 10 has the preference P for the message M. On the other hand, although the user terminal 10 opens the APP but exits the APP soon without watching any stream, the evaluating unit 120 evaluates that the user terminal 10 has no preference P for the message M. Once the user terminal 10 performs a behavior after operating message M, the user terminal 10 transmits data to the message distribution system 100. Different data corresponds to different types of behavior. The evaluating unit 120 evaluates the preference P for the message M according to different types of data.

In some embodiments, the collecting unit 110 collects feedbacks F on messages M from the user terminal 10 dynamically. More specifically, the collecting unit 110 does not only collect the real-time feedback F, but the historical feedback F. In other words, the feedback F includes real-time feedback F and historical feedback F. More specifically, the response action feedback Fr further includes real-time response action feedback Fr and historical response action feedback Fr. Similarly, the influence action feedback Fi further includes real-time influence action feedback Fi and historical influence action feedback Fi.

As shown in FIG. 2, the evaluating unit 120 further includes a message analysis element 121, a frequency analysis element 122 and a relevance analysis element 123. The message analysis element 121 is configured to analyze, filter and/or screen a user message Mu the user terminal 10 left in the APP. The frequency analysis element 122 is configured to identify a frequency Freq of the user terminal 10's feedback F on the message M. The relevance analysis element 123 is configured to analyze a relevance R between the message M and the feedback F.

In some embodiments, the message analysis element 121 is configured to identify the contents of the user message Mu left by the user terminal 10. The user message Mu may be articles, comments, chat bubbles, emoji and so on, and contents of the user message Mu may be text, picture, sound, audio, video message and so on. The message analysis element 121 may be configured to determine if the user message Mu (such as a piece of chat content) is positive, negative or neutral. In some embodiments, the message analysis element 121 has a keyword identification part, to identify a keyword in the user message Mu, and to evaluate the preference P based on the keyword. For example, the message analysis element 121 may identify positive contents such as “do”, “good”, “like”, “love”, “interesting”, smile emoji and the like in a user message Mu, and evaluate that the user message Mu is positive. On the other hand, the message analysis element 121 may identify negative contents such as “not”, “bad”, “dislike”, “boring”, sad emoji and the like in a user message Mu, and evaluates that the user message Mu is negative. In some embodiments, if no positive or negative contents are identified, the message analysis element 121 may evaluate that the user message Mu is neutral.

In some embodiments, the evaluating unit 120 evaluates the preference P of the user terminal 10 according to the user message Mu. For example, the evaluating unit 120 evaluates that the user terminal 10 has a preference P for the message M if the user terminal 10 comments on a streamer in a streaming room and the comments are positive, which means that the user terminal 10 likes the streamer. On the other hand, if the user terminal 10 comments on the streamer and the comments are negative, it shows that the user terminal 10 has no preference P for the message M. In some embodiments, if the user message Mu is neutral, the user message Mu does not contribute to the preference P.

In some embodiments, the frequency analysis element 122 may identify the frequency Freq of the feedback F. More specifically, the frequency analysis element 122 may identify the frequency Freq of the response action feedback Fr and/or the influence action feedback Fi. The frequency analysis element 122 may be configured to calculate the frequency Freq of the user terminal 10's operation and/or behavior, and determine if the frequency Freq is positive, negative or neutral.

In some embodiments, the evaluating unit 120 evaluates the preference P of the user terminal 10 according to the frequency Freq from the frequency analysis element 122. If the user terminal 10 has a specific operation and/or behavior frequently, it shows that the user has the preference P for the message M. For example, the user terminal 10 watches a streamer every time after clicking the message M, so the frequency analysis element 122 analyzes that the frequency Freq is positive and the evaluating unit 120 evaluates that the user terminal 10 has a preference P for the message M. In some embodiments, the frequency Freq may be referred to as the number of times of a specific operation and/or behavior. if the number of times is higher, between or lower than a specific range, it shows that the frequency Freq is high, intermediate or low. Once the evaluating unit 120 receives the data of the user terminal 10, the evaluating unit 120 evaluates the similarity of the types of data with respect to the message M. If there is similar or the same types of data with respect to the message M, the frequency analysis element 122 begins to calculate the frequency Freq. With different frequency Freq, it may contribute a different increment or decrement to the preference P.

In some embodiments, the frequency analysis element 122 may further detect the continuity of the operation and/or behavior. For example, if the user terminal 10 watched a streamer frequently such as everyday, but the user terminal 10 did not watch the streamer in one day, the frequency analysis element 122 detects that the frequency Freq is not continuous. In this situation, the user terminal 10 may be busy and forget to watch the streamer, the pushing unit 130 may push the message M or a reminder message to the user terminal 10. However, if the user terminal 10 did not click the message M and watch the streamer anymore, the frequency analysis element 122 analyzes that the frequency Freq is negative. On the other hand, if the user terminal 10 starts to click the message M and watches the streamer, the frequency analysis element 122 may analyze that the frequency Freq is positive.

In some embodiments, the frequency analysis element 122 further detects the consistency of the operation and/or behavior. For example, if the user terminal 10 watches a streamer every time when clicking the message M, but the user terminal 10 does not follow the streamer, the frequency analysis element 122 may detect the inconsistency between watching a streamer and following a streamer. In this situation, the pushing unit 130 may push a message M′ related to the message M such as recommending to follow the streamer, giving free gifts for following the streamer or the like. In some embodiments, the collecting unit 110 may further collect a feedback F′ on the message M′ and the evaluating unit 120 may further evaluate the preference P′ for the message M′ of the user terminal 10.

In some embodiments, the relevance analysis element 123 may be configured to identify the relevance R between the message M and the feedback F. More specifically, the relevance analysis element 123 is configured to identify the contents of the message M and the operation and/or the behavior of the user terminal 10, and determine the relevance R between the message M and the feedback F. The relevance analysis element 123 may be configured to determine whether the relevance R is relevant or irrelevant.

In some embodiments, the evaluating unit 120 evaluates the preference P of the user terminal 10 according to the relevance R from the relevance analysis element 123. Sometimes, the user terminal 10's behavior has nothing to do with the contents of the message M. For example, the message M may recommend the user terminal 10 to watch a streamer's live streaming. Even though the user terminal 10 clicks the message M, the user terminal 10 watches another streamer instead of watching the recommended streamer. In this situation, the relevance R of the message M and the behavior is irrelevant and the feedback F may not contribute to the preference P. On the other hand, if the relevance R is relevant, the feedback F may contribute to the preference P. By means of that, the accuracy of the preference P can be improved.

In some embodiments, if the relevance R is relevant, it may further be classified into positively relevant or negatively relevant. For example, the message M may recommend the user terminal 10 to watch a streamer's live streaming. After clicking and watching the streamer, the user terminal 10 may subscribe or unsubscribe to the streamer. the relevance analysis element 123 may determine the relevance R as positively relevant or negatively relevant, and then contribute an increment or decrement respectively to the preference P.

In some embodiments, the feedback F may further include time information. The evaluating unit 120 further evaluates the preference P according to the time information. More specifically, the evaluating unit 120 further evaluates the preference P according to a time information of the response action feedback Fr and an influence action feedback Fi. The time information may refer to a time period such as in the evening, in the morning, at noon, at night, on the weekday, on the weekend or on vacation. The time information may also refer to a time span of getting involved in the APP such as 1 minute, 10 minutes, 1 hour or more. The time information may also refer to the time zone of the user terminal 10 such as Japan time zone or the U.S. time zone. For example, the user terminal 10 tends to click the message M and watch live streaming at night, so the evaluating unit 120 evaluates that the user terminal 10 has the preference P for operating the message M and performing behavior at night. The user terminal 10 always swipes to delete the message M in the morning, so it shows that the user terminal 10 has no preference P for the message M in the morning.

In some embodiments, the feedback F may further include a location information. The evaluating unit 120 further evaluates the preference P according to the location information. More specifically, the evaluating unit 120 further evaluates the preference P according to a location information of the response action feedback Fr and an influence action feedback Fi. The location information may refer to country, city, town, home, workplace, restaurant or the like. The location information may also refer to a transportation means such as automobile, bus, rail, ship, airplane, or the like. For example, the user terminal 10 clicks the message M and watches streaming home, so the evaluating unit 120 evaluates that the user terminal 10 has the preference P for operating the message M at home. The user terminal 10 always swipes to delete the message M in the workplace, so it shows that the user terminal 10 has no preference P for the message M in the workplace. In some embodiments, the pushing unit 130 may further push the message M to other users with similar location information. For example, A large number of users in Taipei city has visited Arthur's profile, the pushing unit 130 may push the message M to other users in Taipei city to recommend them to watch the streamer.

In some embodiments, the feedback F may further include device information. The evaluating unit 120 further evaluates the preference P according to the device information. More specifically, the evaluating unit 120 further evaluates the preference P according to a device information of the response action feedback Fr and an influence action feedback Fi. The user terminal 10 may generate the APP by a device such as mobile phone, table, smart appliance and the like. The device information may refer to a current mode of the device, such as in a turnoff mode, standby mode, idle mode, busy mode or the like. The device information may also refer to a mode the user terminal 10 sets such as do not disturb mode, quiet mode, silent mode or the like. For example, the user tends to swipe to delete the message while being in busy mode, so it shows that the user terminal 10 has no preference P for the message M while being in busy mode.

In some embodiments, the device information may also include an operation time from the message being read to the message being operated. The evaluating unit 120 may evaluate the preference P according to the operation time. In some embodiments, if the message M is operated right after the message M is read, it may show that the user terminal 10 tends not to check the contents of the message M or even does not like any kind of message. For example, if the user terminal 10 clicks the message M in less than 1 second, it may show that the user terminal 10 tends not to check the message M and always clicks any kind of messages M, so the feedback F may not contribute to the preference. If the user terminal 10 swipes to delete the message M in less than 1 second without checking the contents of the message M, it may show that the user terminal 10 does not like to receive any kind of messages.

In some embodiments, the evaluating unit 120 may further evaluate the preference P according to the combination of the above information. For example, the user terminal 10 in New York city frequently clicks the message M and watches live streaming in the evening, the evaluating unit 120 evaluates that the user terminal 10 with time information of “in the evening” and with location information of “New York city” has a preference P for the message M. In some embodiments, the combination of the above information may be decided according to practical need.

In some embodiments, the preference P may be evaluated according to a retention rate of the user terminal. The retention rate may refer to the rate the user terminal 10 comes back and opens the APP after receiving the message M. In some embodiments, the retention rate may be the number of times of opening the APP or the length of engaging in the APP during a period of time. In some embodiments, the period of time may be 3 days, 7 days, 14 days or the like. For example, if the number of times of opening the APP or length of engaging in the APP in the following 7 days is increased after receiving the message M, it shows that the user terminal 10 has the preference P for the message M.

In some embodiments, the preference P may also be evaluated according to other criteria such as push notification click rate, push notification unsubscribe rate, session length on opening APP and getting involved in the APP through push notification, frequency of opening APP or the like. If the push notification click rate is increased, it shows that the user terminal 10 has the preference P for the message M. If the push notification unsubscribe rate is increased, it shows that the user has no preference P for the message M. If the number of times of opening the APP by clicking the message M is increased, it shows that user terminal 10 has the preference P for the message M. If the time length of engaging in the APP is increased, it shows that the user terminal 10 has the preference P for the message M. If the frequency of opening APP is increased, it shows that the user terminal 10 has the preference P for the message M.

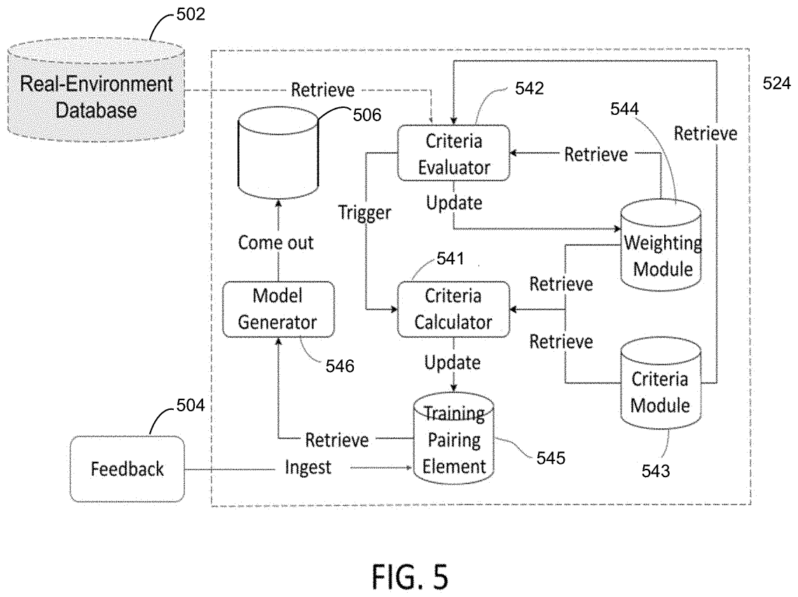

In some embodiments, the evaluating unit 120 may further include a preference evaluating element 124. The preference evaluating element 124 is configured to evaluate the preference P according to the feedback F by means of the criteria above. In some embodiments, the preference evaluating element 124 may evaluate the preference P by means of the criteria respectively or a combination of the criteria above. FIG. 5 is a schematic block diagram of the preference evaluating element 124 according to some embodiments of subject application. The evaluating element 124 includes a criteria calculator 541, a criteria evaluator 542, a criteria module 543 and a weighting module 544. The criteria calculator 541 is configured to calculate the preference P according to the criteria or the combination of the criteria. The criteria evaluator 542 is configured to evaluate the criteria and the corresponding weighting for each criterion in order to calculate the preference P. The criteria module 543 is configured to store the criteria for calculating the preference P. The weighting module 544 is configured to store the weightings for each criterion.

As shown in FIG. 5, the criteria evaluator 542 retrieves the criteria and the corresponding weightings from the criteria module 543 and the weighting module 544. The criteria evaluator 542 may evaluate the corresponding weighting for each criterion to determine suitable weighting for each criterion. After the weighting for each criterion is determined, the criteria evaluator 542 may update the weighting module 544. Then the criteria calculator 541 may retrieve the criteria and the corresponding weightings to calculate the preference P. For example, the criteria evaluator 542 may retrieve some criteria such as criterion C1, criterion C2 and criterion C3 from the criteria module 543. In some embodiments, the criterion C1 may be push notification click rate, the criterion C2 may be session length on getting involved in the APP through push notification, and criterion C3 may be frequency of opening APP.

Once the criteria are determined, the criteria evaluator 542 may evaluate the weighting for each criterion. For example, the criteria evaluator 542 may evaluate the weighting W1, weighting W2 and weighting W3 for criterion C1, criterion C2 and criterion C3 respectively. In some embodiments, the total of the weighting W1, W2 and W3 may be 1 and the weighting W1, W2 and W3 may be 0.3, 0.3 and 0.4 by default, for example. In some embodiments, the default values of weightings may be determined based on the practical need. In some embodiments, the weightings may vary dynamically accordingly.

In some embodiments, the criteria evaluator 542 may evaluate the weighting according to a real-environment data from a real-environment database 502. As shown in FIG. 5, the criteria evaluator 542 may retrieve the real-environment data from the real-environment database 502. In some embodiments, the real-environment data may include the real-environment data of the APP. For example, the real-environment data may be the time length the user terminal 10 gets involved in the APP, or the total profit the user 10 contributes to the APP. More specifically, the profit the user 10 contributes may be the gift or reward the user terminal 10 bought, donated or received, or the business value of the APP. The criteria evaluator 542 may adjust the weightings for each criterion if the real-environment data is decreased or is not increased as expected. The criteria evaluator 542 may further trigger the criteria calculator 541 to generate a formula for calculating the preference P. The formula may be like the following:

Preference P=W1*C1+W2*C2+W3*C3 (1)

In some embodiments, the evaluating element 524 may further include a training pairing unit 545 and a model generator 546. The criteria evaluator 542 may evaluate the criteria C1-C3, adjust the weighting W1-W3 and trigger the criteria calculator 541 to update the training pairing unit 545. The training pairing unit 545 is configured to train and pair the preference P updated by the criteria calculator 541 and the feedback F 504. The model generator 546 is configured to generate a model for the preference P with respect to the feedback F 504. In some embodiments, the training pairing unit 545 ingests the feedback F 504, trains the preference P updated by the criteria calculator 541, and pairs the preference P for the feedback F 504. The model generator 546 retrieves the preference P and the feedback F 504 and generates a model for the preference P and the feedback F 504. In some embodiments, the weightings vary dynamically with respect to the real-environment data, for example. More specifically, the criteria calculator 541, the criteria evaluator 542, the training pairing unit 545 and the model generator 546 works dynamically to generate a suitable model for the preference P with respect to the feedback F 504. Eventually, the well-trained models 506 came out from the model generator 546. According to the present application, a more accurate preference P for the feedback F 504 may be evaluated and the user satisfaction for the message M such as push notification may be improved. Furthermore, the click rate of the message, the click rate, involving time and the business value of the APP may be improved accordingly.

In some embodiments, the evaluating unit 120 may further be configured to identify if there is a change in a user's operation and/or behavior resulting in increased or decreased retention rate. In this situation, the pushing unit 130 may orient the user terminal 10 toward a certain feedback by pushing a corresponding message in order to increase the retention rate or other criteria.

In some embodiments, the message distribution system 100 may be behavior-oriented. More specifically, the message distribution system 100 may orient the user terminal 10 toward a specific behavior by pushing an orientation message Mo with positive preference Po. For example, the message distribution system 100 may orient the user terminal 10 toward watching a streamer's live streaming. In order to orient the user terminal 10 toward watching the streamer, the pushing unit 130 pushes an orientation message Mo to the user terminal 10. The orientation message Mo has a positive preference Po from most of the users, or from the same group as the user terminal 10. The pushing unit 130 pushes the orientation message Mo to the user terminal 10 to orient the user terminal 10 toward the similar operation and/or behavior. In some embodiments, the collecting unit 110 may further collect a feedback Fo on the orientation message Mo and the evaluating unit 120 may further evaluate the preference Po for the orientation message Mo of the user terminal 10.

In some embodiments, the evaluating unit 120 evaluates the preference P for the message M and determines whether the pushing unit 130 pushes the message M to the user terminal 10 or not. In some embodiments, the pushing unit 130 may further push a message M′ related to the message M based on the preference P. For example, the message M recommends John watching Paul's streaming, John clicks the streaming and gifts Paul during the streaming. Next time when Paul is streaming again then the message M may be pushed to John. Furthermore, A message M′ about free gifts or discount information may be pushed to John in the future. In some embodiments, the pushing unit 130 may further recommend a recommendation message Mr to the user terminal 10 according to an operation and/or behavior in the APP. For example, the user terminal 10 opens the APP and scrolls down the feed but exits without watching any stream, the pushing unit 130 may push a recommendation message Mr to recommend the user terminal 10 another stream or discount information.

In some embodiments, the preference P may be expressed as a percentage and a default of the preference P may be 50%. The feedback F may be classified as positive, negative or neutral feedback F. More specifically, the operation may be classified as positive, negative and neutral operation. The behavior may be classified as positive, negative and neutral behavior. Once a positive, negative or neutral operation is operated, the preference P may be increased by an increment, decreased by a decrement or constant. Similarly, once a positive, negative or neutral behavior is performed, the preference P may be increased by an increment, decreased by a decrement or constant.

If the preference P is higher than a threshold Th, the evaluating unit 120 evaluates the user terminal 10 has a preference P, and the pushing unit 130 may further push the message M to the user terminal 10 in the future. On the other hand, if the preference P is lower than a threshold T1, the evaluating unit 120 evaluates the user terminal 10 has no preference P, and the pushing unit 130 may stop pushing the message M to the user terminal 10. Moreover, if the preference P is within the threshold Th and the threshold T1, the pushing unit 130 and the collecting unit 110 may keep pushing the message M and collecting the feedback F 504 to the evaluating unit 120 may keep evaluating the preference P for the message M of the user terminal 10 to determine if the user terminal 10 has a preference P for the message M.

In some embodiments, the increment and the decrement may be 3%, 5%, 10% or the like. The threshold T1 may be 20%, 30%, 40% or the like. The threshold Th may be 60%, 70%, 80% or the like. In some embodiments, the default of the preference P, the increment, decrement, the threshold T1 or the threshold Th may be determined depending on practical needs.

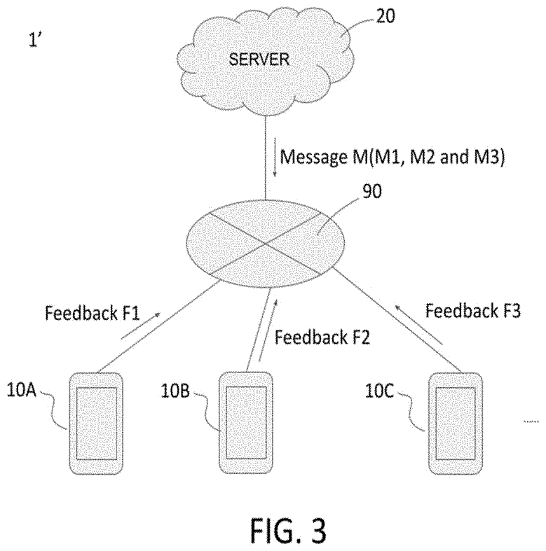

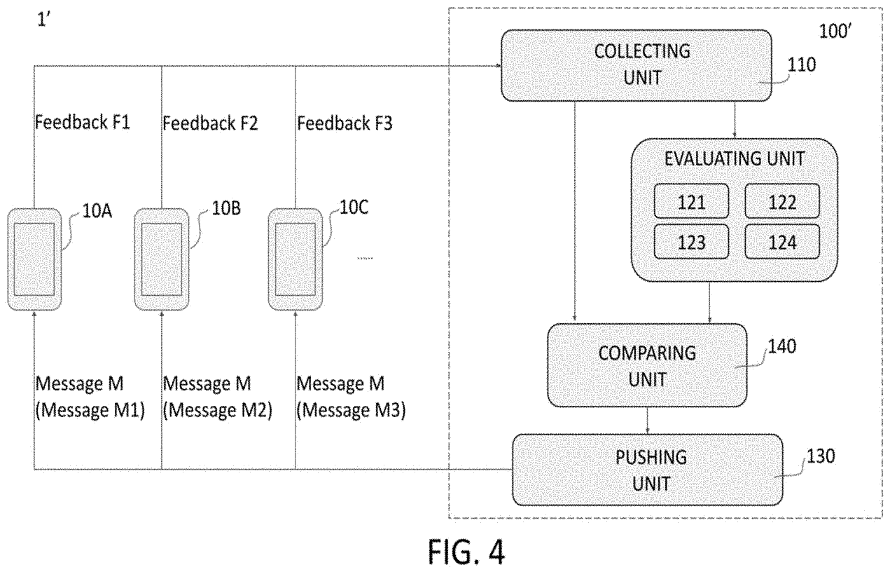

FIG. 3 is a schematic configuration of a communication system 1′ according to some embodiments of subject application. FIG. 4 is a schematic block diagram of the message distribution system 100′ according to some embodiments of subject application. To facilitate understanding, identical reference numerals have been used, where possible, to designate identical elements that are common to the figures. As shown in FIG. 3, The communication system 1′ includes user terminal 10A, user terminal 10B, user terminal 10C, and a server 20. The user terminals 10A-10C and the server 20 are connected via a network 90, which is the Internet, for example. Server 20 includes a message distribution system 100′. The communication system 1′ may include a plurality of users, and the user terminal 10A, user terminal 10B and user terminal 10C are shown in FIG. 3 for simplification.

The message distribution system 100′ includes a collecting unit 110, an evaluating unit 120, a pushing unit 130 and a comparing unit 140. The collecting unit 110 is configured to collect feedback F1, F2 and F3 on a message M from a user terminal 10A, 10B and 10C respectively. The evaluating unit 120 is connected to the collecting unit 110 and configured to evaluate a preference P1, P2 and P3 for the message M of the user terminal 10A, 10B and 10C according to the feedback F1, F2 and F3.

As shown in FIG. 4, the comparing unit 140 is connected to the collecting unit 110 and the evaluating unit 120 respectively, and is configured to compare the feedback F1, F2 and/or F3 from the collecting unit 110 and the preference P1, P2 and/or P3 to the feedback F1, F2 and/or F3 from the evaluating unit 120. More specifically, the comparing unit 140 compares the feedback F collected from a plurality of users and the preference P to the feedback F evaluated by the evaluating unit 120. The pushing unit 130 is connected to the comparing unit 140 and configured to push the message M to the user terminal 10.

In some embodiments, the comparing unit 140 compares the feedback F1 and the preference P1 from one specific user such as the user terminal 10A. More specifically, the comparing unit 140 compares whether the preference P1 is consistent with the feedback F1. For example, if the user terminal 10A clicks the message M and purchases a premium membership and the evaluating unit 120 evaluates that the user terminal 10A has a preference P for the message M. Clicking message M may be referred to as a positive operation and Purchasing a premium membership may be referred to as an positive behavior. Therefore, the comparing unit 140 compares the feedback F and the preference P and confirms that the preference P is consistent with the feedback F.

In some embodiments, the comparing unit 140 may be configured to detect whether the preference P1 for the message M of the user terminal 10A has changed. The comparing unit 140 may compare the real-time feedback F1 with historical feedback F1 from the user terminal 10A. If the real-time feedback F1 is consistent with the historical feedback F1, it shows that the preference P1 does not change. On the other hand, if the real-time feedback F1 is not consistent with the historical feedback F1, it may be predicted that the preference P1 for the message may be changed. For example, the user terminal 10A used to click the message M in the past, so it shows that the user terminal 10A had preference P for the message M. However, the user terminal 10A is swiping to delete the message M in real-time, so it shows that the user terminal 10A has no preference P1 for the message M. Therefore, the comparing unit 140 compares the real-time feedback F1, which is swiping to delete the message M, with the historical feedback F1, which is clicking the message M, and detects that the preference P1 for the message M has changed.

In some embodiments, the comparing unit 140 compares the feedback F1, F2 and F3 on the message M from a plurality of users such as the user terminal 10A, 10B and 10C. If the feedback F1 is similar to the feedback F2, the user terminal 10A and the user terminal 10B may be classified into the same group. If the feedback F1 is different from the feedback F3, the user terminal 10A and the user terminal 10C may be classified into different groups. For example, if the user terminal 10A clicks the message M and follows a streamer and the user terminal 10B also does so, it shows that the user terminal 10A and the user terminal 10B have similar preference for the message M. In this situation, the user terminal 10A and user terminal 10B may be classified into the same group. On the other hand, if the user terminal 10C swipes and deletes the message M, it shows that the user terminal 10A and the user terminal 10C have different preferences for the message M and the user terminal 10A and the user terminal 10C may be classified into different groups. Here, being similar may be referred to having the same operation and/or behavior, and being different may be referred to having different operations and/or behaviors.

As shown in FIG. 4, the pushing unit 130 may push the message M1, M2 and M3 to the user terminal 10A, 10B and 10C respectively. The collecting unit 110 may collect feedback F1, F2 and F3 on the message M1, M2 and M3 from a user terminal 10A, 10B and 10C respectively. The evaluating unit 120 may evaluate a preference P1, P2 and P3 for the message M1, M2 and M3 of the user terminal 10A, 10B and 10C according to the feedback F1, F2 and F3. If the user terminal 10A has a preference P1 for the message M1 according to the feedback F1, the message M1 may further be recommended to the user in the same group such as the user terminal 10B. In some embodiments, the collecting unit 110 may further collect feedback on the message M1 to the user terminal 10B and the evaluating unit 120 may further evaluate the preference for the message M1 of the user terminal 10B. Furthermore, a message M′ related to the message M1 may further push to the users in the same group such as user terminal 10A and user terminal 10B. On the other hand, if the user terminal 10C and user terminal 10C belongs to different groups, the message M1 and the related message M′ may not be recommended to the user terminal 10C.

In some embodiments, the comparing unit 140 may compare the real-time feedback F1, F2 and F3 on message M with the historical feedback F1, F2 and F3 from a plurality of users such as the user terminal 10A, 10B and 10C. If the real-time feedback F2 is similar to the historical feedback F1, it may be predicted that the user terminal 10B has the preference P2 similar to the preference P1 of the user terminal 10A. Furthermore, if the real-time feedback F2 is similar to the historical feedback F1, the user terminal 10B may be classified into the same group as the user terminal 10A. On the other hand, if the real-time feedback F3 is different from the historical feedback F1, the preference P3 of the user terminal 10C may not be predicted according to the preference P1 of the user terminal 10A. The user terminal 10C may be classified into different groups from the user terminal 10A.

In some embodiments, the comparing unit 140 may compare the preference P1, P2 and P3 on the message M from a plurality of users such as the user terminal 10A, 10B and 10C. Even if the user terminal 10A, 10B and 10C have different feedback F1, F2 and F3, they may have the same preference P1, P2 and P3 for the message M. For example, the message M recommends the user terminal 10A and the user terminal 10B a streamer. With respect to the message M, the user terminal 10A checks the streamer's profile and the user terminal 10B watches the streamer. Even if their behaviors are not the same, both of their behaviors are positive. Therefore, the preference P1, P2 for the message M are similar. If the preference P1 is similar to the preference P2, the user terminal 10A and the user terminal 10B may be classified into the same group. On the other hand, if the preference P1 is different from the preference P3, the user terminal 10A and the user terminal 10C may be classified into different groups.

In some embodiments, Even if the user terminals 10A, 10B and 10C have similar feedback F1, F2 and F3, they may have different preferences P1, P2 and P3 for the message M. For example, the message M recommends the user terminal 10A and the user terminal 10B to watch a streamer. With respect to the message M, the user terminal 10A comments on the streamer with an angry emoji but the user terminal 10B comments with a smile emoji. Even if their behaviors are the same, their preference P1, P2 for the message M are different. Therefore, for the users in the same group, they may be further classified into subgroups. For example, if the user terminal 10A, 10B and 10C have the similar preference P1, P2 and P3 for the message, user terminal 10A, 10B and 10C may be classified into the same group. With respect to the similar preference P1, P2 and P3, if the feedback F1 and the feedback F2 are similar, the user terminal 10A and the user terminal 10B may further be classified into the same subgroup. For the users in the subgroup will have much similarity than the users not in the subgroup.

In some embodiments, if the message M is related to a streamer, the pushing unit 130 may further push the feedback F on the message M from a plurality of user terminal 10 to the streamer. The streamer may take the feedback F as reference to improve his or her performance. For example, the message M may recommend the viewers to check the streamer's singing. However, most of the viewers do not click the message M. It shows that most of the viewers are not interested in the streamer's singing. The pushing unit 130 may push the feedback F and the preference P to the streamer and the streamer may understand that the viewers are not interested in his or her singing. The streamer may perform a dance next time instead of singing. In some embodiments, the message M may include a report and suggestions to the streamer. The report may include the monthly report of the streamer such as the streamer's received coins, streaming hours or streaming valid hours.

Furthermore, the system and method described in the above embodiments may be provided with a computer-readable non-transitory storage device such as a solid state memory device, an optical disk storage device, or a magnetic disk storage device. Alternatively, the programs may be downloaded from a server via the Internet.

Although technical content and features of the present invention are described above, a person having common knowledge in the technical field of the present invention may still make many variations and modifications without disobeying the teaching and disclosure of the present invention. Therefore, the scope of the present invention is not limited to the embodiments that are already disclosed, but includes another variation and modification that do not disobey the present invention, and is the scope covered by the following patent application scope.

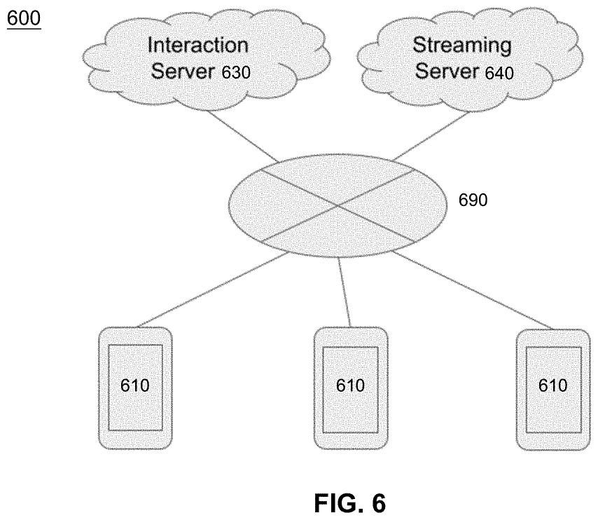

FIG. 6 shows a schematic configuration of a communication system 600 according to some embodiments of subject application. The communication system 600 provides a live streaming service with interaction via a content. Here, the term “content” refers to a digital content that can be played on a computer device. In other words, the communication system 600 enables a user to have a real-time interaction with other users on-line. The communication system 600 includes plural user terminals 610, an interaction server 630, and a streaming server 640. The user terminals 610, the interaction server 630, and the streaming server 640 are connected via a network 690, which is the Internet, for example. The interaction server 630 is a server for synchronizing interaction feedback. In some embodiments, the interaction server 630 may be referred to as the backend server of an APP. The streaming server 640 is a server for providing live streaming. In some embodiments, the streaming server 640 may be referred to as a CDN provider. In some embodiments, the interaction server 630 and the streaming server 640 may be integrated into one server. The user terminals 610 are client devices for the live streaming. In some embodiments, the user terminal 610 may be referred to as viewer, streamer, podcaster, audience, listener or the like. Each of the user terminal 610, the interaction server 630, and the streaming server 640 is an example of an information-processing device.

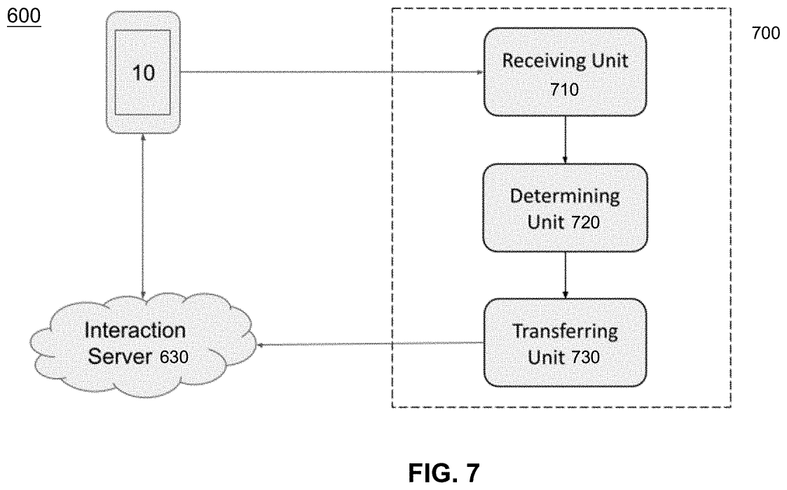

FIG. 7 is a schematic block diagram of the data communication system 700 according to some embodiments of subject application. The data communication system 700 includes a receiving unit 710, a determining unit 720 and a transferring unit 730. The receiving unit 710 is configured to receive an action A performed by an user terminal 610. In some embodiments, the receiving unit 710 may include a storage element. The storage element is configured to store the action A collected from the user terminal 610. The determining unit 720 is connected to the receiving unit 710 and configured to determine a communication protocol P toward the user terminal 610 according to the action A. The transferring unit 730 is connected to the evaluating unit 120 and configured to transfer the communication protocol P to the interaction server 630 and/or the streaming server 640. In some embodiments, the interaction server 630 and/or the streaming server 640 may receive and/or transmit real-time data toward the user terminal 610 via the communication protocol P in response to the action A.

As shown in FIG. 7, the user terminal 610 performs an action A and the receiving unit 710 receives the action A performed by the user terminal 610. In some embodiments, the action A may include requesting receiving and/or transmitting real-time data from and/or to a server. Then, the receiving unit 710 transmits the action A to the determining unit 720, and the determining unit 720 determines a communication protocol P toward the user terminal 610 according to the action A. Then, the transferring unit 730 receives the communication protocol P determined by the determining unit 720 and transfers the communication protocol P to the interaction server 630. The interaction server 630 transmits the communication protocol P to the user terminal 610 for the user terminal 610 to request the streaming data. In some embodiments the data communication system 700 may be integrated into the interaction server 630. More specifically, the receiving unit 710, determining unit 720 and the transferring unit 730 may be integrated into the interaction server 630. The interaction server 630 may include a storage for storing the action A performed by the user terminal 610. In some embodiments, the storage may be configured to store historical action A performed by the user terminal A. For the user terminal 610 which gets access to the interaction server 630 first time, the determining unit 720 may determine a communication protocol P toward the user terminal 610 according to the historical action A. For the user terminal 610 which gets involved in the interaction server 630 for a specific time, the determining unit 720 may determine a communication protocol P toward the user terminal 610 according to the real-time action A.

The action A may refer to an operation the user terminal 610 performed in an APP. The action A may include clicking, sending, interacting, swiping, silencing, muting, expanding, minimizing, or other operations the user 10 may perform, and the combination of above. In some embodiments, the action A may be achieved by clicking a graphical object such as a button or audio input or the like. For example, the user terminal 610 may click a gift to send the gift to the streamer. The user terminal 610 may minimize the live stream screen or display the live stream room in a picture-in-picture mode while multitasking with other APPs or other live streaming at the same time. The user terminal 610 may silence or mute the live stream while watching the live steaming in a quiet place. The user terminal 610 may click a button to have an audio and/or video communication with viewers or streamers. The user terminal 610 may play interactive games with the viewers or streamers in the APP.

There are a lot of communication protocols for real-time data communication such as HLS, RTP(WebRTC), RTMP, RTSP, DASH, MirrorOP and so on, and each communication protocol P has its advantages and disadvantages for real-time data communication. In the present invention, the communication protocols of HLS, RTC(WebRTC) and RTMP are taken as examples to discuss. Table 1 shows the exemplary communication protocol P and the advantages and disadvantages for reference.

TABLE 1

| Communication | | | |
|---|---|---|---|
| Protocols | Video Latency | Buffering | First Render |
| HLS | | Recommended | Recommended |
| RTMP | Recommended | | Highly |
| | | | Recommended |
| WebRTC | Highly | | |
| | Recommended | | |

When it comes to real-time interaction, video latency may be one of the most important indexes to be considered. Here, the index “video latency” may refer to the degree of delay between the time the streaming data is transferred from one user terminal and the time the first frame of the streaming data is rendered at the other user terminal. WebRTC offers near real-time latency with less than 0.5 second, so WebRTC is highly recommended for real-time interaction. Similarly, the latency of RTMP is often 5-8 seconds, so RTMP is also recommended for real-time data communication. However, HLS has relatively high latency compared with WebRTC and RTMP, so HLS is not recommended for real-time interaction.

When it comes to smoothness of the live streaming, low buffering may be some of the most important indexes to be considered. The index “buffering” may further be classified into “buffering ratio” and “buffering count”. The index “buffering ratio” refers to the ratio of the buffering time to the totally watching time. The index “buffering count” refers to the number of times the buffering occurs. HLS (HTTP Live Streaming) is an HTTP-based adaptive bitrate streaming communication protocol. HLS measures the internet speed available to each viewer and changes the quality accordingly to ensure the smoothness of the streaming data. Therefore, HLS is recommended for smoothness of the live streaming.

RTMP is based on Transmission Control Protocol (TCP), and it allows data communication in a given sequence and order with delivery guarantee. One of the advantages of RTMP is that the time to first render is relatively short compared with WebRTC and HLS. Here, the index “first render”, which may also be called “time to view”, refers to the time from the streaming data being requested to the first frame of the streaming data being rendered. Therefore, RTMP is recommended for the action A of requesting a short time to first render.

In some embodiment, the real-time data may include streaming data and interaction data. The streaming data refers to audio contents and/or video contents. The audio contents and video contents may be collected from a microphone or camera from the user terminal 610. The interaction data refers to data showing an interaction with the user terminals 610. For example, the interaction data may refer to operations the user terminal 610 performed to interact with other user terminals 610. For example, the user terminal 610 may click a gift to send the gift to the streamer. The user terminal 610 may click the enter button to send a message to the streamer. The terminal 610 may click the game button to have an interactive game with the streamer.

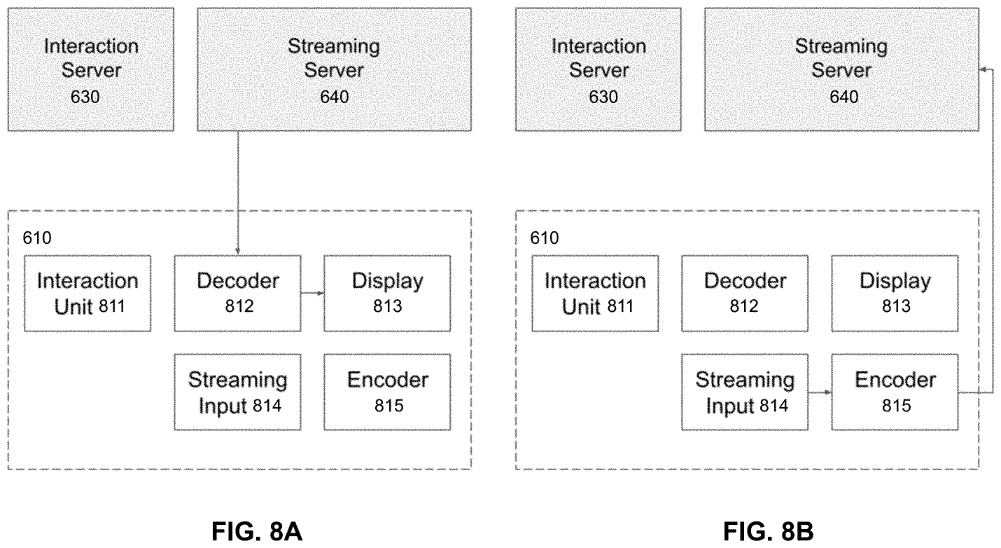

FIG. 8A-10 are exemplary functional configurations of the action A. In FIG. 8A to FIG. 10, the user terminal 610, the interaction server 630 and the streaming server 640 are shown. The interaction server 630 transmits and receives interaction data and the streaming server 640 transmits and receives streaming data. The user terminal 610 includes an interaction unit 811, a decoder 812, a display 813, a streaming input 814 and an encoder 815. The interaction unit 811 receives interaction data from the interaction server 630 and/or transmits interaction data to the interaction server 630. The decoder 812 decodes the streaming data from the streaming server 640 and the display 813 displays the streaming data. The streaming input 814 collects streaming data from the user terminal 610. The encoder 815 encodes the streaming data collected from the streaming input 814 and transmits the streaming data to the streaming server 640. In some embodiments, the streaming input 814 may be a microphone or a camera for collecting audio contents and video contents from the user terminal 610.

In some embodiments, the action A may further include an interaction action Ai and a non-interaction action Ani. The determining unit 720 may determine the communication protocol P toward the user terminal 610 according to the interaction action Ai and the non-interaction action Ani.

In some embodiments, the interaction action Ai may refer to the actions A that transmits and/or receives interaction data. For example, if the user terminal 610 clicks the gift button to send a gift to the streamer, the user terminal 610 transmits an interaction data to the streamer. In this situation, the action A of sending a gift may be referred to as an interaction action Ai. If the user terminal 610 clicks the game button to have an interactive game with the streamer such as shooting monsters together, the user terminal 610 transmits interaction data to the streamer and receives interaction data from the streamer. In this situation, the action A of playing interactive games may be referred to as an interaction action Ai.

In some embodiments, the interaction action Ai may also refer to the actions that transmits and receives streaming data. For example, the viewer may click the voice call button or video call button to invite the streamer to have a voice chat or video chat. In this situation, the action A of inviting the streamer to have a voice chat or video chat may be referred to as an interaction action Ai.

The non-interaction action Ai may refer to the actions A of receiving without transmitting streaming data or transmitting without receiving streaming data. For example, if the user terminal 610 watches the streamer without doing anything, the user terminal 610 receives the streaming data from the streamer without transmitting streaming data or interaction data to the streamer. In this situation, the action A of watching the streamer may be referred to as a non-interaction action Ai. If the user terminal 610 is live broadcasting without interaction with other user terminals 610, the user terminal 610 transmits the streaming data without receiving any streaming data or interaction data. In this situation, the action A of live broadcasting may be referred to as a non-interaction action Ai.

FIG. 8A shows an exemplary functional configuration of the non-interaction action Ani. In some embodiments, the user terminal 610 may be referred to as a viewer, listener, audience or the like. The user terminal 610 requests receiving streaming data from the streaming server 640. The streaming data may include the audio and video contents from the streamer. As shown in FIG. 8A, the user terminal 610 receives streaming data from the streaming server 640 and the decoder 812 decodes the streaming data to display the streaming data on the display 813.

According to the action A, the user terminal 610 requests receiving streaming data, so it shows that the user terminal 610 would like to watch a streamer. Therefore, the action A may be referred to as a non-interaction action Ani. In response to the non-interaction action Ani, the buffering and first render of the streaming data would be the first priority to fulfill the user satisfaction. Therefore, the determining unit 720 may determine the HLS or RTMP as the communication protocol P toward the user terminal 610 according to the action A. In some embodiments, when the user terminal 610 clicks a streamer and enters a streaming room, a short first render is preferred. Therefore, the communication protocol P of RTMP is recommended. In some embodiments, after entering the streaming room, the low buffering is preferred. Therefore, the communication protocol P of HLS may be recommended.

In some embodiments, the determining unit 720 may further determine the communication protocol P toward the user terminal 610 according to internet quality of the user terminal 610. For example, if the internet quality of the user terminal 610 is good, the communication protocol P of RTMP is recommended. On the other hand, if the internet quality of the user terminal 610 is bad, the communication protocol P of HLS is recommended. In some embodiments, the good and bad of the internet quality may be evaluated according to the index of latency, buffering, first render or the like. For example, if the buffering is high, it shows that the user terminal's internet quality is bad. On the other hand, if the buffering is low, it shows that the user terminal's internet quality is good. The determining unit 720 may further determine the communication protocol P according to the internet quality of the user terminal 610.

In some embodiments, the streaming data may be audio contents only. The determining unit 720 may determine the communication protocol P toward the user terminal 610 for receiving the streaming data with audio contents only. For example, the user terminal 610 may minimize the live stream to listen to the streamer's voice only, or the user terminal 610 may click a podcaster to listen to the live podcasting. In response to the action A of pulling streaming data with audio contents only, the communication protocol P of RTMP may be recommended, for example. Therefore, the determining unit 720 determines RTMP as the communication protocol P toward the user terminal 610. The communication protocol P of RTMP may pull the streaming data with audio contents only to lower the network traffic, so that the audio contents may be played smoothly.

In some embodiments, the streaming data may be video contents only. The determining unit 720 may determine the communication protocol P toward the user terminal 610 for receiving the streaming data with video contents only. For example, the user terminal 610 may silence or mute the live stream to watch streamer's video only when the user terminal 610 is at a quiet place such as the library. In response to the action A of pulling streaming data with video contents only, the communication protocol P of RTMP and HLS may be recommended. Therefore, the determining unit 720 determines such as RTMP or HLS as the communication protocol P toward the user terminal 610.

In some embodiments, the user terminal 610 may perform an action A of receiving streaming data from different user terminals 610 continuously in a short time. Here, the “short time” refers to the time for the user terminal 610 to receive streaming data from a first streamer and receive another streaming data from a second streamer once the streaming data from first streamer is rendered on display for watching. The determining unit 720 may determine the communication protocol P according to the action A. For example, the user terminal 610 may swipe the live streaming rooms quickly to check if there are streamers the user terminal 610 is interested in. In other words, the user terminal 610 requests receiving streaming data from different user terminals 610 quickly, such as 1-3 seconds for each request. In this situation, the time length to first render the video would be the shorter the better in order to check different streamers as quickly as possible. The communication protocol P of RTMP may be recommended in response to the action A. Therefore, the determining unit 720 may determine RTMP as the communication protocol P toward the user terminal 610.

In some embodiments, the user terminal 610 may perform an action A of receiving streaming data from different streamers concurrently. The determining unit 720 may determine different communication protocols P toward the user terminal 610 for each streaming data from each streamer according to the action A. For example, the user terminal 610 may watch different streamers with different windows at the same time. In other words, the user terminal 610 requests receiving streaming data from different user terminals 610 at the same time. In this situation, each streaming data recommends a different communication protocol P. For example, the user terminal 610 may watch a lot of streamers at the same time. The user terminal 610 interacts with his or her favorite streamer while keeping other streams being broadcasted without interaction. In this situation, the real-time interaction with his or her favorite streamer would be the first priority, and the rest streamer's streaming may be recommended to focus on the smoothness of the video. Therefore, the communication protocol P of WebRTC may be recommended for the user terminal 610 to interact with the streamer. The communication protocol P of HLS with low-resolution streaming data is recommended for the rest of live streaming to be broadcasted smoothly.

FIG. 8B shows another exemplary functional configuration of the non-interaction action Ani. In some embodiments, the user terminal 610 may be referred to as a streamer, podcaster or the like. The user terminal 610 requests transmitting streaming data to the streaming server 640. The streaming data may also include the audio and video contents from the user terminal 610. As shown in FIG. 8B, the user terminal 610 collects streaming data from the streaming input 814 such as microphone or camera and the encoder 815 encodes the streaming data to transmit the streaming data to the streaming server 640.

In some embodiments, the streaming data may also include audio contents and/or video contents. The determining unit 720 may determine the communication protocol P toward the user terminal 610 for transmitting the streaming data with audio contents and/or video contents. For example, the streamer may transmit a video, short video, live stream, podcasting and the like. In response to the action A above, the determining unit 720 may determine communication protocols P toward the user terminal 610.

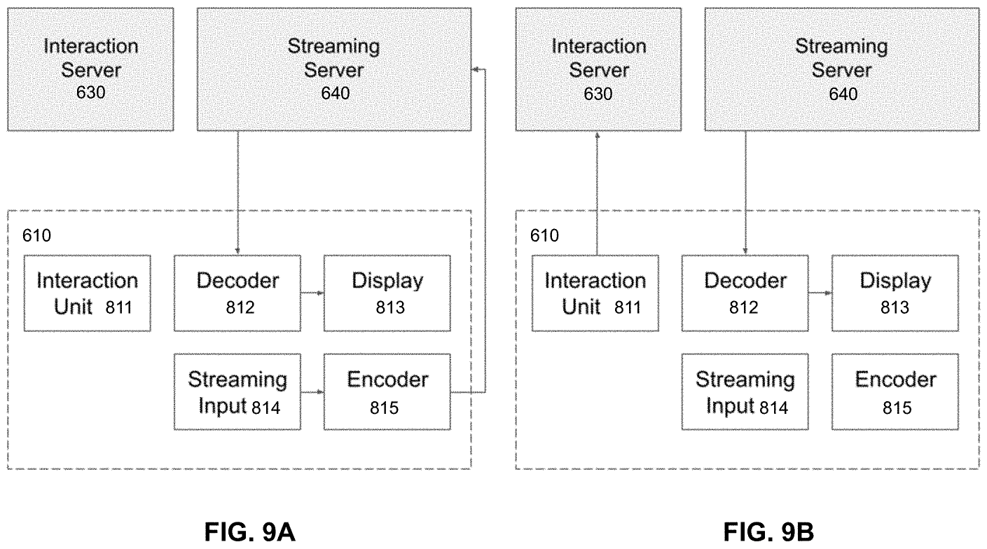

FIG. 9A shows an exemplary functional configuration of the interaction action Ai. In some embodiments, the user terminal 610 may be referred to as a viewer, streamer, audience, listener, podcaster or the like. The user terminal 610 requests transmitting streaming data to the streaming server 640 and receiving streaming data from the streaming server 640. As shown in FIG. 9A, the user terminal 610 receives streaming data from the streaming server 640 and the decoder 812 decodes the streaming data to display the streaming data on the display 813. At the same time, the user terminal 610 collects streaming data from the streaming input 814 and the encoder 815 encodes the streaming data to transmit the streaming data to the streaming server 640. Similarly, the streaming data may include audio contents and/or video contents. For example, the viewer may click the voice call button or video call button to invite the streamer to have a voice chat or video chat. The streamer may click a button to accept the voice chat or the video chat. The action A of inviting or accepting the voice chat or the video chat may be referred to as an interaction action Ai. Therefore, the communication protocol P of WebRTC, for example, may be recommended.

FIG. 9B shows another exemplary functional configuration of the interaction action Ai. In some embodiments, the user terminal 610 may also be referred to as a viewer, streamer, audience, listener, podcaster or the like. The user terminal 610 requests receiving streaming data from the streaming server 640 and transmitting interaction data to the interaction server 630. As shown in FIG. 9B, the user terminal 610 receives streaming data from the streaming server 640 and the decoder 812 decodes the streaming data to display the streaming data on the display 813. At the same time, the user terminal 610 transmits an interaction data to the interaction server 630. For example, the viewer may click the gift button to send a gift to the streamer while watching or listening to the streamer or podcaster. The interaction data may trigger a dynamic sticker on the streamer's screen and the streamer may express the gratitude by voice or gesture in response to the interaction data from the user terminal 610. Therefore, the communication protocol P of WebRTC, for example, may be recommended.

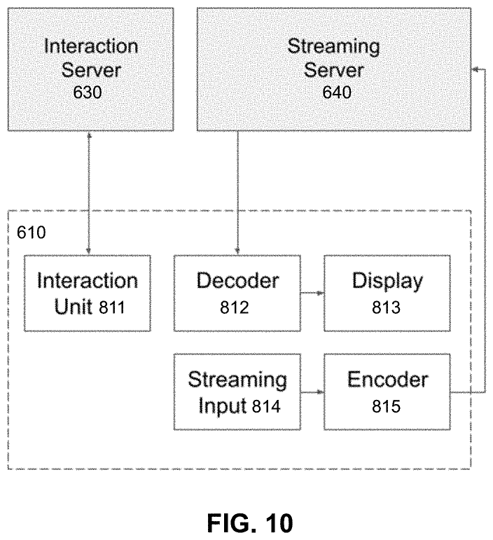

FIG. 10 shows another exemplary functional configuration of the interaction action Ai. In some embodiments, the user terminal 610 may also be referred to as a viewer, streamer, audience, listener, podcaster or the like. The user terminal 610 requests transmitting interaction data to the interaction server and receiving interaction data from the interaction server 630. In some embodiments, the user terminal 610 may further transmit streaming data to the streaming server 640 and receive streaming data from the streaming server 640. As shown in FIG. 10, the user terminal 610 transmits and receives interaction data to and from the interaction server 630 at the same time. The user terminal 610 may further receive and/or transmit streaming data from and/or to the streaming server 640 at the same time. For example, the viewer may click the interaction button to have interactive games with the streamer. Therefore, the communication protocol P of WebRTC, for example, may be recommended.

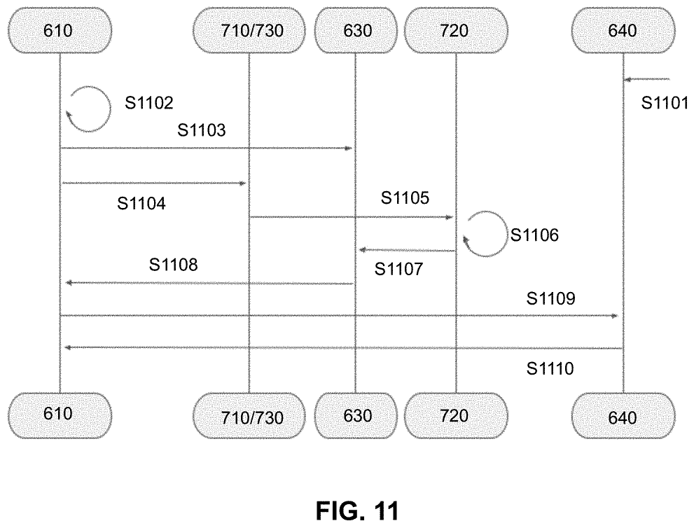

FIG. 11 shows an exemplary sequence chart illustrating an operation of the communication system 600 and the data communication system 700. In step S1101, the client application APP in the user terminal upload live streaming data to the streaming server 640, in response to an instruction by the user terminal such as a streamer. Here, the live stream includes streaming data collected from the microphone and/or the camera. In many cases, the streaming data includes audio and video contents of the streamer.

In step S1102, the client application APP in the user terminal 610 performed an action A in an APP or platform. In some embodiments, the action A may be logging in the APP and clicking streamers to view the live streaming. In step S1103, the user terminal 610 sends a request for live streaming data information to the interaction server 630 in response to the action A. In step S1104, the receiving unit 710 receives the action A performed by the user terminal 610. In some embodiments, the receiving unit 710 stores the action A in a storage element. In step S1105, the receiving unit 710 transmits the action A performed by the user terminal 610 to the determining unit 720. In step S1106, the determining unit 720 determines a communication protocol P toward the user terminal 610 according to the action A. In step S1107, the determining unit 720 transmits the communication protocol P to the interaction server 630. In step S1108, the interaction server 630 transmits the communication protocol P to the user terminal 610. In step S1109, the user 10 requests streaming data via the communication protocol P. In step S1110, the streaming server 640 transmits the streaming data via the communication protocol P in response to the request from the user terminal 610.

In some embodiments, the receiving unit 710, determining unit 720 and the transferring unit 730 may be integrated into one server. In some embodiments, the receiving unit 710, determining unit 720 and the transferring unit 730 may be integrated into the interaction server 630. In some embodiments, the receiving unit 710 and the transferring unit 730 may be replaced with the receiving means and transferring means of the interaction server 630.

In some embodiments, the action A the user terminal 610 performed in step S1102 may be an interaction action Ai. More specifically, in step S1102, the user terminal 610 may perform an action A. For example, the action A may include watching a streamer and clicking the gift button to send a gift to the streamer. In step S1103, the user terminal 610 requests transmitting interaction data to the interaction server 630 and receiving streaming data from the streaming server 640 in response to the action A. In step S1104, the receiving unit 710 receives the action A performed by the user terminal 610. In step S1105, the receiving unit 710 transmits the action A performed by the user terminal 610 to the determining unit 720. In step S1106, the determining unit 720 determines a communication protocol P toward the user terminal 610 according to the action A. More specifically, the user terminal 610 requests transmitting interaction data and receiving streaming data according to the action A, so it shows that the user terminal 610 would like to watch the streamer and interact with the streamer by sending a gift to the streamer. Therefore, the action A may be referred to as an interaction action Ai. In response to the interaction action Ai, the real-time interaction would be the first priority to fulfill the user satisfaction. Therefore, the determining unit 720 determines such as WebRTC or RTMP as the communication protocol P toward the user terminal 610 according to the action A.

In some embodiments, the action A may include watching the streamer and clicking the interaction game button to have an interactive game with the streamer. In step S1103, the user terminal 610 requests transmitting interaction data to the interaction server 630 and receiving interaction data from the interaction server 630 in response to the action A. In step S1106, the determining unit 720 determines a communication protocol P toward the user terminal 610 according to the action A. According to the action A, the user terminal 610 requests transmitting and receiving interaction data, so it shows that the user terminal 610 would like to interact with the streamer by playing an interactive game such as shooting monsters together. Therefore, the action A may be referred to as an interaction action Ai. In response to the action A, the real-time interaction especially the short latency would be the first priority to fulfill the user satisfaction. Therefore, the determining unit 720 determines such as WebRTC as the communication protocol P toward the user terminal 610.

In some embodiments, the determining unit may further include a predicting element. The predicting element is configured to predict the following action A according to the action A. The predicting element analyzes the action A to identify relevant actions and predicts the following action A based on the relevant actions. For example, the user terminal 610 clicks the input box, it implies that the user terminal 610 would like to start a chat with the streamers. If the user terminal 610 clicks the gift box, it may be predicted that the user terminal 610 is going to send a gift to the streamer. In some embodiments, the predicting element may further analyze the message left by the user terminal 610 and predict the following action A according to the message. The message left by the user terminal 610 may include text, audio, emoji and so on. For example, the user terminal 610 may enter a text to ask the streamer to have an interactive game, so it may be predicted that the user terminal 610 is going to have an interactive game with the streamer. In response to the request of interactive games from the user terminal 610, if the streamer responds with Okay via audio message such as microphone, it may also imply that the user terminal 610 and the streamer is going to have an interactive game. Therefore, the predicting element may analyze the message the user terminal 610 left and the audio message the streamer said and predict that the user terminal 610 is going to have an interactive game with the streamer. In some embodiments, the determining unit 720 may further determine the communication protocol P according to the following action A.

In some embodiments, the predicting element may collect a plurality of historical data from the user terminal 610. The historical data may include the historical actions A and historical following actions A from the user terminal 610. The predicting elements may predict the following action A according to the historical actions A and historical following actions A. For example, the user terminal 610 is accustomed to have video and audio chat with a specific streamer after entering the streamer's live stream, it may be predicted that the user terminal 610 may have video and audio chat with the stream once user terminal 610 enters the streamer's room.

In some embodiments, the receiving unit 710 further receives available communication protocols from the user terminal 610. The available communication protocols refer to the communication protocols P which are mutually applicable to the user terminal 610 and the server 630/40. In some embodiments, the determining unit 720 may select the communication protocol P from the available communication protocols and further determines the communication protocol P according to the action A.

In some embodiments, the data communication system 700 may further include a feedback collecting unit. The feedback collecting unit is configured to collect feedback from the user terminal 610 and transmit the feedback to the determining unit 720. In some embodiments, the determining unit 720 determines the communication protocol P according to the feedback. For example, the user terminal 610 may have feedback on the real-time data communication. The feedback may be satisfaction or dissatisfaction with the communication. The determining unit 720 may take the feedback as reference to determine the communication protocol P.

In some embodiments, the receiving unit 710 may receive internet quality of the user terminal 610. The determining unit 720 may determine a communication protocol P toward the user terminal 610 according to the internet quality. The internet quality may be evaluated according to the indexes such as first render (time to view), video latency, buffering ratio, or buffering count.

In some embodiments, the determining unit 720 may evaluate the four indexes and determine the communication protocol P according to the four indexes. More specifically, the determining unit 720 analyzes one of the indexes such as the video latency, checks which communication protocol P has the shortest video latency, and determines the communication protocol P with shortest video latency toward the user terminal 610 according to the internet quality of the user terminal 610. For example, if the user terminal 610 sends a request to the interaction server 630, the receiving unit 710 may receive the internet quality of the user terminal 610. The determining unit 720 may evaluate the buffering while communicating via each communication protocol P and determine the communication protocol P with the lowest buffering toward the user terminal 610.

In some embodiments, the user terminal 610 may receive and transmit real-time data from different streaming servers 40. The determining unit 720 may determine a streaming server 640 toward the user terminal 610 according to the internet quality. In some embodiments, the streaming server 640 may be referred to as a CDN (Content Delivery Network) provider. As shown in FIG. 11, the determining unit 720 may further determine a streaming server 640 toward the user terminal 610 according to the internet quality in step S1106. More specifically, the determining unit 720 may evaluate the internet quality of the user terminal 610 via different streaming servers 40. For example, the determining unit 720 evaluates buffering of the streaming data while the user terminal 610 communicates with different streaming servers 40 and determines the streaming servers 40 with the shortest buffering toward the user terminal 610. In step S1108, the interaction server 630 transmits the information of the streaming server 640 to the user terminal 610. In some embodiments, the information of the streaming server 640 may be a URL of the streaming server 640. In step S1109, the user 10 requests streaming data via the streaming server 640. In step S1110, the streaming server 640 transmits the streaming data in response to the request from the user terminal 610. Therefore, the data communication system 700 may access the user terminal 610 to a suitable streaming server 640 for better user experience.

In some embodiments, the receiving unit 710 may further receive historical data from the user terminal 610. The historical data may further include the historical internet quality, geographical location and time information of the user terminal 610. The determining unit 720 may evaluate the historical data and determine the streaming server 640 toward the user terminal 610 in advance. For example, it shows that the users in a specific location during a specific time have the shortest video latency via a specific streaming server 640 according to the historical data, the determining unit 720 may determine the streaming server 640 toward users from the specific location during the specific time in advance.

Furthermore, the system and method described in the above embodiments may be provided with a computer-readable non-transitory storage device such as a solid state memory device, an optical disk storage device, or a magnetic disk storage device. Alternatively, the programs may be downloaded from a server via the Internet.

Although technical content and features of the present invention are described above, a person having common knowledge in the technical field of the present invention may still make many variations and modifications without disobeying the teaching and disclosure of the present invention. Therefore, the scope of the present invention is not limited to the embodiments that are already disclosed, but includes another variation and modification that do not disobey the present invention, and is the scope covered by the following patent application scope.

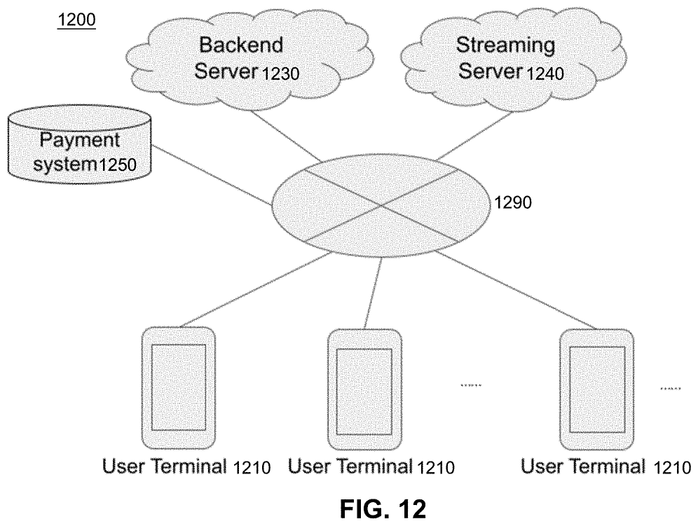

FIG. 12 shows a schematic configuration of a communication system 1200 according to some embodiments of subject application. The communication system 1200 provides a live streaming service with interaction via a content. Here, the term “content” refers to a digital content that can be played on a computer device. In other words, the communication system 1200 enables a user to have a real-time interaction with other users on-line. The communication system 1200 includes plural user terminals 1210, a backend server 1230, a streaming server 1240 and a payment system 1250. The user terminals 1210, the backend server 1230, the streaming server 1240 and the payment system 1250 are connected via a network 1290, which may be the Internet, for example. The backend server 1230 may be a server for synchronizing interaction feedback. In some embodiments, the backend server 1230 may be referred to as the backend server of an APP provider. The streaming server 1240 is a server for handling streaming data 1402. In some embodiments, the streaming server 1240 may be referred to as a content delivery network (CDN) provider. In some embodiments, the backend server 1230 and the streaming server 1240 may be independent servers or may be integrated into one server. The payment system 1250 is a system for dealing with financial transactions. In some embodiments, the payment system 1250 may be an independent system, or may be integrated into the backend server 1230. In other words, the backend server 1230 may deal with the financial transactions via the payment system 1250 integrated in the backend server 1230, or redirect the user terminal 1210 to a payment system 1250 separated from the backend server 1230. The user terminals 1210 are client devices for the live streaming. In some embodiments, the user terminal 1210 may be referred to as viewer, streamer, podcaster, audience, listener or the like. Each of the user terminal 1210, the backend server 1230, the streaming server 1240 and the payment system 1250 is an example of an information-processing device. In some embodiments, the stream may be live streaming or video replay. In some embodiments, the stream may be audio streaming and/or video streaming. In some embodiments, the content of the stream may be online shopping, talk shows, talent shows, entertainment events, sports events, music videos, movies, comedy, concerts or the like.

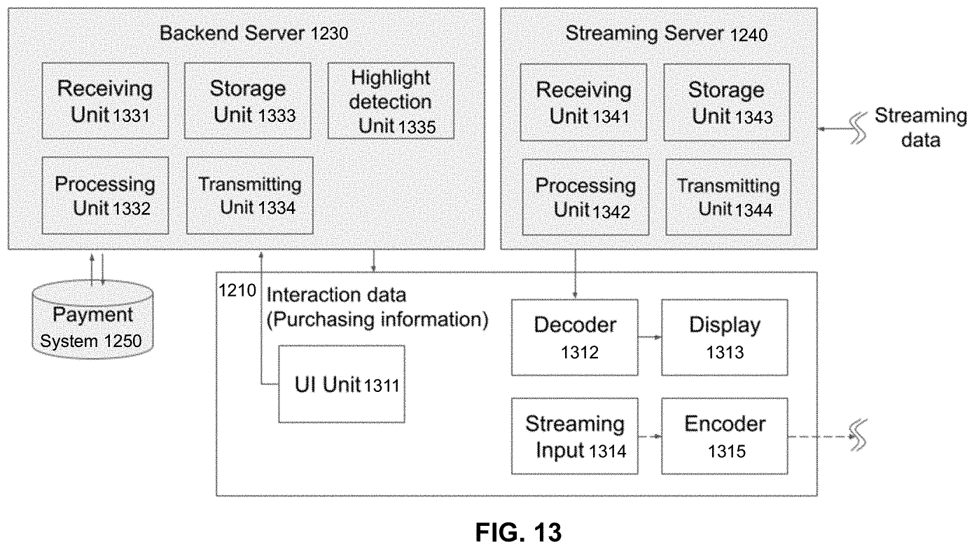

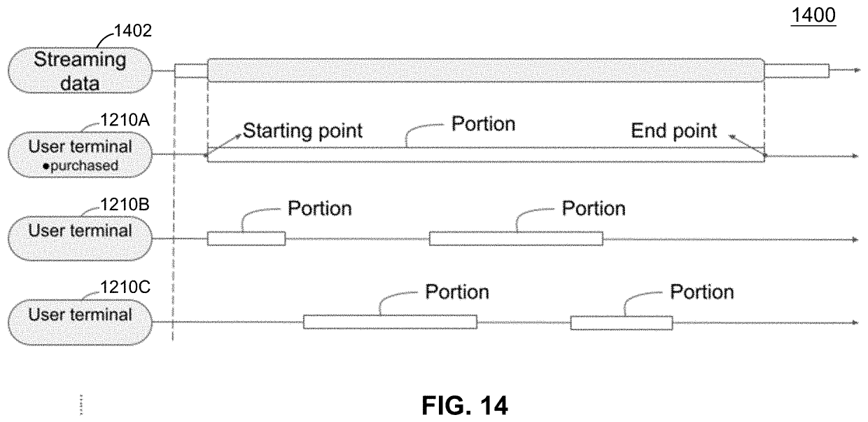

FIG. 13 shows an exemplary functional configuration of the communication system 1200, a highlight detection system and a highlight detection unit 1335. FIG. 14-FIG. 20 are exemplary functional configurations of the highlight detection unit 1335. The communication system 1200 may include a plurality of user terminals. In FIG. 14-FIG. 20, the user terminal 1210A, user terminal 1210B and user terminal 1210C are shown for simplification. FIG. 14-FIG. 20 shows a timeline of a streaming data 1402 and the corresponding portions the user terminal 1210A, 1210B and 1210C have watched respectively. In FIG. 14-FIG. 20, the arrow line of the streaming data 1402 shows the timeline of the video, and the rectangular bar of the streaming data 1402 may be referred to as the portions including streaming data 1402. The arrow line of the user terminals 1210A, 1210B and 1210C show the timeline of the user terminals, and the rectangular bar of the user terminals 1210A, 1210B and 1210C may be referred to as the portions the user terminals 1210A, 1210B and 1210C watched corresponding to the streaming data 1402.

As shown in FIG. 13, a user terminal 1210 includes a UI unit 1311, a decoder 1312, a display 1313, a streaming input 1314 and an encoder 1315. The backend server 1230 includes a receiving unit 1331, a processing unit 1332, a storage unit 1333, a transmitting unit 1334 and a highlight detection unit 1335. The streaming server 1240 includes a receiving unit 1341, a processing unit 1342, a storage unit 1343 and a transmitting unit 1344. In some embodiments, one user terminal (not shown in FIG. 13) may transmit or push its streaming data 1402 to the streaming server 1240. In some embodiments, the user terminal here may be referred to as a streamer, an online shopping service provider or a live streaming service provider or the like. The receiving unit 1341 receives the streaming data 1402 from a user terminal. The processing unit 1342 determines the destination of the received streaming data 1402. The transmitting unit 1344 transmits the streaming data 1402 to the determined destination. For example, the transmitting unit 1344 transmits the streaming data 1402 to the user terminal 1210. In some embodiments, the user terminal 1210 here may be referred to as a viewer or a potential purchaser. In some embodiments, the storage unit 1343 may store various data and programs. In some embodiments, the user terminal 1210 may receive or pull the streaming data 1402 from the streaming server 1240. The decoder 1312 decodes the received streaming data 1402 and generates the video to be displayed on the display 1313. The display 1313 previews or shows the video on the computer screen of the user terminal 1210.

For example, the streaming data 1402 may be live streaming data 1402 for online shopping services. The user terminals 1210 may be potential buyers and sellers respectively. The seller pushes or uploads live streams for online shopping service. The buyer may select the live streams that the buyer gets interested in and click the live streams to pull or download the live streams from the seller. For another example, the streaming data 1402 may be live streaming data 1402 for entertainment events such as talent shows or musical performances. In this example, the user terminal 1210 may also be audiences and performers respectively. The performer pushes or uploads live streams for performance such as talk shows or talent shows. The audience may select the live streams that the audience gets interested in and click the live streams to pull or download the live streams from the performer. In some embodiments, the user terminal 1210 may also push and pull live streaming data 1402 at the same time.

The user terminal 1210 may perform a variety of actions while watching the streams. In some embodiments, a user of the user terminal 1210 or the user terminals 1210 may tap an icon to trigger the UI unit 1311 to generate and communicate interaction data with the backend server 1230. For example, the viewers may chat with the streamer, comment on the streamer, click the like button, send gifts to the streamer, check the gift store, purchase gifts, purchase a token or the like in an entertainment show. In some embodiments, the viewers may comment on the products, inquire about products, click the like button, add products to wishlist, add products to favorite, add products to shopping cart, check available coupons discount tickets or gift certificates, click the buy button, establish an order, finish the payment or the like in an online shopping event.

As shown in FIG. 13, the user terminal 1210 may transmit interaction data to the backend server 1230. The receiving unit 1331 is configured to receive a variety of interaction data from the user terminals 1210. The processing unit 1332 is configured to process the interaction data. In some embodiments, the processing unit 1332 determines the destination of the received interaction data. For example, if the viewer sends a message to the streamer, the processing unit 1332 may determine the destination to be the streamer. If the viewer adds the interested products to the shopping cart, the processing unit 1332 may determine the destination to be the processing unit 1332 and store the data in the processing unit 1332 described later. If the viewer made a purchase of the products, the processing unit 1332 may determine the destination to be the payment system 1250 and access the user terminal 1210 to the payment system 1250, or redirect the user terminal 1210 to the payment system 1250 for financial transactions. The processing unit 1332 is configured to store various data and programs. The transmitting unit 1334 is configured to transmit the interaction data to the determined destination. For example, the transmitting unit 1334 may transmit the interaction data to the streamers, viewers, payment system 1250 or the like. In some embodiments, the receiving unit 1331, transmitting unit 1334 and highlight detection unit 1335 may be referred to as a highlight detection system. In other words, the highlight detection system may include the receiving unit 1331, transmitting unit 1334 and highlight detection unit 1335.

In some embodiments, the highlight detection unit 1335 collects purchasing information from the user terminal 1210. In some embodiments, the purchasing information may include purchasing data from the user terminal 1210. In some embodiments, the user terminal 1210 may perform purchasing actions while watching the streams. In some embodiments, the purchasing actions may be referred to as the actions related to purchase of the user terminal 1210. In some embodiments, the purchasing actions may include actions such as clicking the buy button, establishing an order, finishing the payment or the like. The highlight detection unit 1335 may collect the purchasing actions as purchasing data. In other words, the purchasing information may include purchasing actions of the user terminal 1210. More specifically, the purchasing information may include the information that whether the viewer clicks the buy button, whether the order is established, whether the payment is finished or the like.

In some embodiments, the purchasing information may include pre-purchasing data from the user terminal 1210. In some embodiments, the user terminal 1210 may perform pre-purchasing actions while watching the streams. In some embodiments, the pre-purchasing actions may be referred to as the actions that show the willingness or intention to make a purchase. In some embodiments, the pre-purchasing actions may include actions such as enlarging pictures of products, checking descriptions of products, adding products to wishlist, adding products to favorite, adding products to shopping cart, checking available coupons, discount tickets, gift certificates or the like. The highlight detection unit 1335 may collect the pre-purchasing actions as pre-purchasing data. In other words, the purchasing information includes pre-purchasing actions. More specifically, the pre-purchasing data may include the information that whether the viewer enlarges pictures of the products, checks descriptions of products, adds products to wishlist, whether the viewer adds products to favorite, whether the viewer adds products to shopping cart, whether the viewer checks available coupons, discount tickets, gift certificates or the like.

In some embodiments, the purchasing information may include the corresponding time information of portions of the stream the user terminal 1210 watched. In some embodiments, the time information may include the time point from which the user terminal 1210 begins to watch the video. In some embodiments, the time information may include the time point at which the user terminal 1210 finished watching the streams. In some embodiments, the time information may include the time period during which the user terminal 1210 watched the streams.

In some embodiments, the highlight detection unit 1335 may detect the highlight according to the purchasing information. More specifically, the highlight detection unit 1335 may check the user terminal 1210's payment status and select the user terminal(s) 10 who has(have) payment record. In some embodiments, the highlight detection unit 1335 may collect purchasing information from plural user terminals 1210. For example, the highlight detection unit 1335 may check whether the user terminal 1210 has finished the payment. If the user terminal 1210 has finished the payment, the highlight detection unit 1335 may capture the portions the user terminal 1210 has watched and detect the portions as highlights of the streams. In some embodiments, the highlight detection unit 1335 may capture the portions the user terminal 1210 has watched according to the time information such as the time point the user terminal 1210 begins to watch, the time point the user terminal 1210 finished watching, the time period the user terminal 1210 is watching the streams or the like. In some embodiments, the highlight detection unit 1335 may check whether the user terminal 1210 has purchasing information by checking whether the user terminal 1210 clicks the buy button, whether the order is established, whether the payment is finished, or a combination of above or the like.

In some embodiments, the purchasing information may include the transaction data. More specifically, the transaction data may include the price of each product and the total price of the products the user terminals 1210 purchased. In some embodiments, the transaction data may include the number of each product and the total number of the product the user terminals 1210 purchased. In some embodiments, the transaction data may include other suitable data related to the transactions. In some embodiments, the highlight detection unit 1335 may detect the highlight according to the transaction data such as the total price of the products or other suitable factors. In some embodiments, the highlight detection unit 1335 may assign a score to the user terminals 1210. In some embodiments, the score may be decided according to the transaction data. For example, if the user terminal 1210 made a purchase at the price of x, the score may be assigned with x. In some embodiments, if a user terminal made a purchase at the price twice as much as another user terminal, the user terminal with the higher purchase price may be assigned with a score twice as much as that of the other user terminal with the lower purchase price, such as 2y and y respectively. In some embodiments, the score assigned to a user terminal is proportional to the purchase price of the user terminal.

In some embodiments, the score may be decided according to the pre-purchasing data or purchasing data. More specifically, the highlights detection unit 35 may set sub-scores for each pre-purchasing data and purchasing data. In some embodiments, the sub-scores for each data may be the same or different. In some embodiments, if the user terminal 1210 has the pre-purchasing data or purchasing data, the highlights detection unit 35 may add the sub-scores to the score and assign the score to the user terminal 1210. For example, the highlights detection unit 35 may set sub-scores of enlarging pictures of the products, adding the products to favorite and adding the products to the shopping cart as x1, x2 and x3. The highlights detection unit 35 may set sub-scores of clicking the buy button, establishing an order and finishing payment as y1, y2 and y3. If the user terminal 1210 enlarges the picture and adds the products to favorite, the score for the user terminal 1210 may be x1+x2. If the user terminal 1210 adds the products to the shopping cart and clicks the buy button to establish an order and finish payment, the score for the user terminal 1210 may be x3+y1+y2+y3. In some embodiments, the score may be decided according to the transaction data, pre-purchasing data, purchasing data or any combination thereof.

In some embodiments, the highlights detection unit 35 may calculate a total score for the streams. In some embodiments, the total score may be the sum of each score from each user terminal 1210. In some embodiments, the total score may be a weighted sum of each score from each user terminal 1210. More specifically, the highlights detection unit 35 may further assign weights to each score. In some embodiments, the weights may be decided according to the transaction data. For example, a relatively high purchasing price may be weighted with a relatively high weight. For another example, one user terminal purchasing twice as much as the other user terminal may be assigned with a weight twice as much as that of the other user terminal. In some embodiments, the scores may be decided according to the pre-purchasing action and purchasing action of the user terminal 1210, and the weights may be decided according to the transaction data of the user terminal 1210. In some embodiments, the weights may be adjustable according to the above factors, or any suitable factors or any combination thereof. Moreover, the weights and scores may be continuously updated based on continued tracking of the above factors.

FIG. 14 shows an example 1400 of the highlight detection unit 1335. In FIG. 14, the user terminal 1210A has purchasing information. In this example, the purchasing information may be the information whether the user terminal 1210A has finished the payment or not. In some embodiments, the purchasing information may be the information whether the user terminal 1210A clicks the buy button, establishes an order or the like. In some embodiments, if the user terminal 1210A has finished the payment, the highlight detection unit 1335 may analyze the portions the user terminal 1210 has watched and detect the highlights according to the portions. More specifically, the highlight detection unit 1335 may collect the purchasing information from the user terminal 1210. In some embodiments, the highlight detection unit 1335 may capture the portions the user terminal 1210A has watched and detect the portions as highlights of the streams. As shown in FIG. 14, the user terminal 1210A watches the streams from starting point to end point. The highlight detection unit 1335 may collect the purchasing information from the user terminal 1210A, which also includes the starting point and end point at which the user terminal 1210A watched the stream. The highlight detection unit 1335 may capture the corresponding portions of the streams according to the starting point and end point. In some embodiments, the highlight detection unit 1335 may detect the portions as highlights.

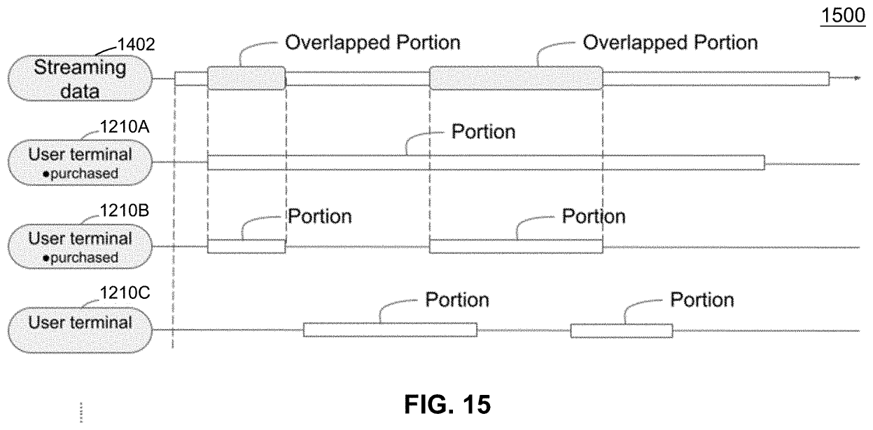

FIG. 15 shows another example 1500 of the highlight detection unit 1335. In FIG. 15, the user terminal 1210B also has purchasing information. In some embodiments, the purchasing information of the user terminal 1210B may be the same as that of the user terminal 1210A, or be different from that of the user terminal 1210A. In some embodiments, the highlights detection unit 35 may also detect the portions the user terminal 1210B has watched as highlights of the streams. In some embodiments, the highlights detection unit 35 may also collect the purchasing information from the user terminal 1210B. In some embodiments, the highlight detection unit 1335 may also capture the portions the user terminal 1210B has watched and detect the portions as highlights of the streams.

In some embodiments, the highlight detection unit 1335 may compare the portions the user terminal 1210A and user terminal 1210B have watched respectively, capture the overlapped portions that both of them have watched, and detect the overlapped portions as the highlights of the stream. In some embodiments, the purchasing information may also include the transaction data the user terminal 1210A and user terminal 1210B have purchased. In some embodiments, the highlights detection unit 35 may assign scores to the user terminal 1210A and user terminal 1210B and calculate a total score for the overlapped portions according to the scores of the user terminal 1210A and user terminal 1210B. In some embodiments, the score may be decided according to the transaction data, pre-purchasing data, purchasing data or any combination thereof.

In some embodiments, the highlights detection unit 35 may assign a score and a corresponding weight to each user terminal according to the transaction data. For example, the user terminal 1210A and 10B may be assigned with the scores Sa and Sb respectively. In some embodiments, the highlights detection unit 35 may assign weights Wa and Wb to the user terminal 1210A and 10B respectively. In this example, the total score may be calculated according to the following expression:

Total score St=Wa*Sa+Wb*Sb (1)

In some embodiments, the scores Sa and Sb may be the same, different or adjustable. In some embodiments, the weights may be decided according to the transaction data. For example, the scores Sa and Sb may be N and N by default. In some embodiments, if the user terminal 1210A and 10B have made purchases and the price the user terminal 1210A purchased is twice as much as the price the user terminal 1210B purchased, the weight Wa may be twice as much as the weight Wb, such as 2w and w, respectively. In this situation, the total score for the overlapped portions may be 2w*N+w*N, which is 3w*N in total. In some embodiments, a portion may be detected as highlighted if the total score exceeds a threshold total score.

In other words, the total score for each portion of the streaming video may be a weighted sum of different scores, and each score may be calculated according to different combinations of factors. In some embodiments, the score for each user terminal may be the same or different. In some embodiments, the score for each user terminal may be determined according to practical need. In some embodiments, the scores and the weights for each user terminal 1210 may be adjusted and determined according to other factors such as the number of the products the user terminal 1210 has purchased, the price of the most expensive product, the combination of above factors or the like.

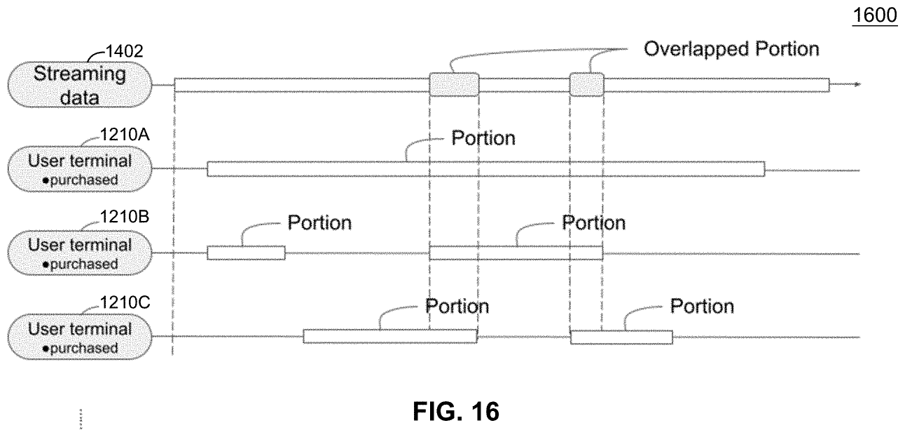

FIG. 16 shows another example 1600 of the highlight detection unit 1335. In FIG. 16, the user terminal 1210C further made a purchase, the highlights detection unit 35 may detect the portions the user terminal 1210C has watched as highlights of the stream. In some embodiments, the highlights detection unit 35 may compare the portions the user terminal 1210A, 10B and 10C have watched and detect the overlapped portions as the highlights of the stream. In some embodiments, the highlights detection unit 35 may also calculate the total score according to the transaction data of each user terminal. In this example, the total score may be based on the following expression:

Total score St=Wa*Sa+Wb*Sb+Wc*Sc (2)

where Sa, Sb and Sc are the scores for each user terminal 1210A, 10B and 10C, and Wa, Wb and We are weights for each user terminal 1210A, 10B and 10C. In some embodiments, a portion may be detected as highlighted if the total score exceeds a threshold total score. In some embodiments the highlight detection unit 1335 may rank portions of the stream based on the total score and detect the portions above a threshold total score as highlights, or detect the portions with top three highest scores as highlights or the like. In some embodiments, the score for each user terminal may be the same. In some embodiments, the score for each user terminal may be determined according to different user terminals. In some embodiments, the scores and weights may be decided according to the transaction data, pre-purchasing data, purchasing data or any combination thereof.

In some embodiments, the purchasing information may include the corresponding time information of the purchasing actions and pre-purchasing actions the user terminal 1210 performed while watching the streams. In other words, the purchasing information may include the time point of the pre-purchasing actions and purchasing actions the user terminal performed. In some embodiments, the time information may include the time point at which the user terminal 1210 performs the purchasing actions and pre-purchasing actions. In some embodiments, the time information may include the time point at which the user terminal 1210 undoes or cancels the purchasing actions and pre-purchasing actions. In some embodiments, the time information may include the time period during which the user terminal 1210 performs the purchasing actions and pre-purchasing actions.

More specifically, the time information may include when the user terminal 1210 clicks the buy button, when the order is established and when the payment is finished corresponding to the streams. In some embodiments, the time information may include when the user terminal 1210 enlarges pictures of products, checks descriptions of products, adds products to wishlist, adds products to favorite, adds products to shopping cart, checks available incentives or the like. For example, the user terminal 1210 clicks the buy button at 10 m50 s from the beginning of the streams, the time information may include the time point at which the user terminal 1210 performed the action.

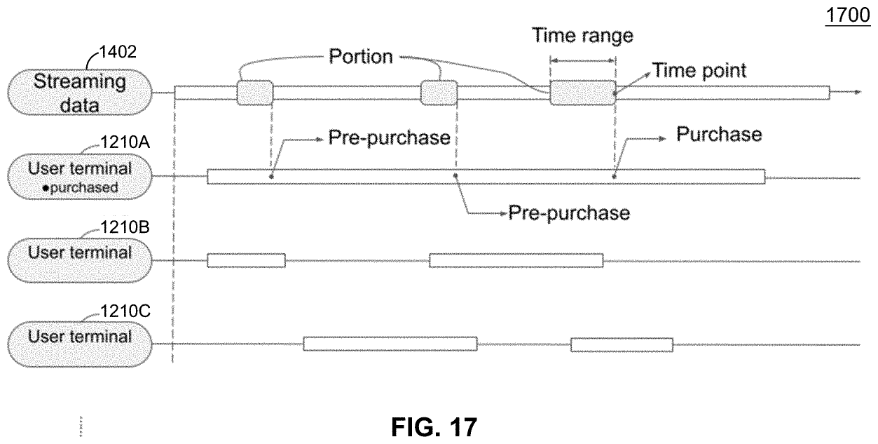

FIG. 17 shows another example 1700 of the highlight detection unit 1335. In some embodiments, the highlight detection unit 1335 may detect the highlights according to the time point of the purchasing information. More specifically, the highlight detection unit 1335 may detect the highlights according to the time point of the pre-purchasing actions and purchasing actions the user terminal performed. For example, if the user terminal 1210 clicks the buy button at 10 m50 s, the highlight detection unit 1335 may detect the highlight of the streams being located around 10 m50 s. In some embodiments, the highlight detection unit 1335 may set a time range with respect to the time point. In some embodiments, the highlight detection unit 1335 may capture the portions according to the time point and time range and detect the portions as the highlights as shown in FIG. 17. More specifically, the highlight detection unit 1335 may capture the highlights of the streaming in the vicinity of the time point. For example, if the viewer clicks the buy button at 10 m50 s, the highlight detection unit 1335 may capture a time range of 3 minutes around the time point of 10 m50 s as the highlights. In some embodiments, the time range may be from 1 second to 10 minutes. In some embodiments, the time range may be 5, 10, 15, 30, 45 seconds, or 1, 2, 3, 5 or 10 minutes. In some embodiments, the time range may be determined according to the practical need. In some embodiments, the time range may have a starting point defined by the time point, an end point defined by the time point, or a middle point defined by the time point. In other words, the time point may be located at the beginning of the time range, in the end of the time range, in the middle of the time range or the like. In some embodiments, the combination of the time range and the time point may be determined according to the practical need.

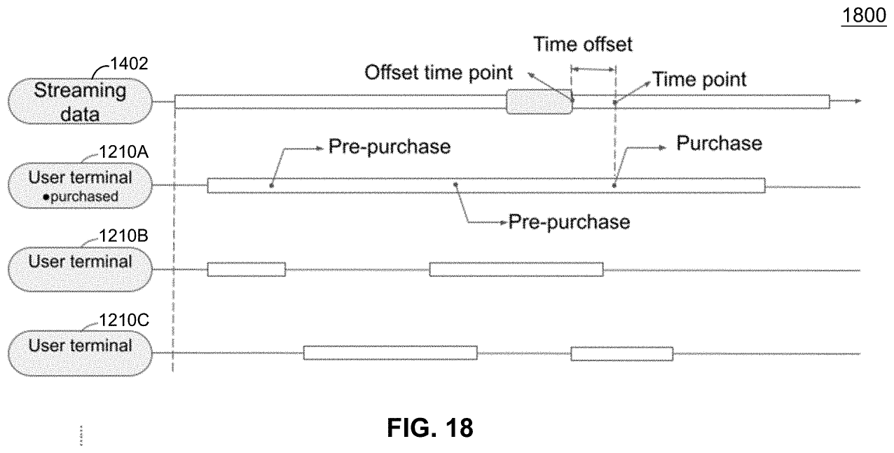

FIG. 18 shows another example 1800 of the highlight detection unit 1335. In some embodiments, the highlight detection unit 1335 may set a time offset for or with respect to the time point corresponding to a purchasing or a pre-purchasing action. In some embodiments, the highlight detection unit 1335 may offset the time point to an offset time point. In some embodiments, the highlight detection unit 1335 may detect the highlights of the stream according to the offset time point. More specifically, the highlight detection unit 1335 may capture portions of the stream according to the offset time point and the time range and detect the portions as the highlights. While watching streams such as online shopping streams, it may take time for the viewers to perform pre-purchasing actions or purchasing actions such as clicking the buy button. In other words, the viewers may be hesitant for a while after noticing the highlights. For example, the viewers may check the wallet to make sure that the products are affordable. The viewers may discuss with friends or wife to make a decision about the purchase. Therefore, setting a time offset may make the highlights more accurate. In some embodiments, the time offset may be from 0 to 10 minutes. In some embodiments, the time offset may be 0, 5, 10, 15, 30, 45 seconds, or 1, 2, 3, 5, 8 or 10 minutes. In some embodiments, the time offset may be set according to the practical need. In some embodiments, the time offset may be set to some specific actions. For example, it takes time to establish an order after the viewer notices the highlight. In this situation, the highlight detection unit 1335 may set a time offset for the action of establishing an order.

In some embodiments, the highlight detection unit 1335 may further detect the highlights of the streaming video according to the purchasing information. In some embodiments, the highlight detection unit 1335 may calculate a score for portions of the streams according to the purchasing information of the user terminals. More specifically, the highlight detection unit 1335 may calculate a score for portions of the streams according to the pre-purchasing actions and purchasing actions. As shown in the FIG. 17, the user terminal 1210A performed a first pre-purchasing action at a first time point. The first pre-purchasing action may be the action of enlarging the pictures of the products. The user terminal 1210A may perform a second pre-purchasing action at a second time point. The second pre-purchasing action may be the action of adding products to the shopping cart. The user terminal 1210A may perform a purchasing action at a third time point. The purchasing action may be the action of clicking the buy button. In some embodiments, each action may be assigned with a sub-score. In this example, the first pre-purchasing action, the second pre-purchasing action and the purchasing action may be assigned with the sub-scores S1, S2 and S3. Therefore, the score for the portions the user terminal 1210A has watched may be Sa=S1+S2+S3.

In some embodiments, the score for the portions a user terminal watches may also be a weighted sum. More specifically the highlight detection unit 1335 may assign different weights to different factors. In this example, the highlight detection unit 1335 may assign weights W1, W2 and W3 to each action. Therefore, the score for the portions the user terminal 1210A has watched may be calculated according to the following expression:

Total score Sa=W1*S1+W2*S2+W3*S3 (3)

In some embodiments, the highlight detection unit 1335 may select factors from the purchasing information. In some embodiments, the subscore of each factor may be the same, different or adjustable according to practical need.

In some embodiments, the scores of different user terminals may be accumulated to calculate the total score of a portion or portions of the streams. In some embodiments, a portion may be detected as a highlight if the total score exceeds a threshold total score. In some embodiments, the highlight detection unit 1335 may also rank portions of the stream based on the total score and detect the portions above a threshold total score as highlights. In some embodiments, the weights may be optional, or assigned to specific factors only. In some embodiments, the highlight detection unit 1335 may use a machine learning model to optimize the score and weights to calculate the score and the total score.

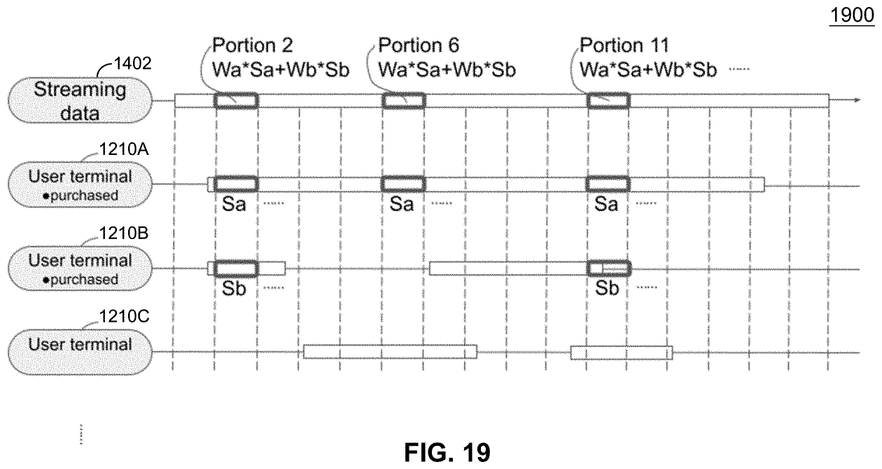

FIG. 19 shows another example 1900 of the highlight detection unit 1335. As shown in FIG. 19, the highlight detection unit 1335 may divide the streams into different portions. In some embodiments, the highlight detection unit 1335 may calculate a total score for each portion. In some embodiments, the highlight detection unit 1335 may detect the highlights according to the total score. In some embodiments, the highlight detection unit 1335 may divide the streams according to the time length of each portion or the number of portions to be divided. More specifically the highlight detection unit 1335 may determine the time length for each portion or the number of portions to be divided. For example, the highlight detection unit 1335 may divide the streams into portions with a specific time length. In some embodiments, the time length may be the same or be different. In some embodiments, the time length may be from 1 second to 10 minutes. In some embodiments, the time length may be 5, 10, 15, 30, 45 seconds, or 1, 2, 3, 5 or 10 minutes. In some embodiments, the time length may be determined according to the practical need. In some embodiments, the highlight detection unit 1335 may divide the streams into several portions. In some embodiments, the number may be 5, 10, 15, 30, 45, 50, 100 or more. In some embodiments, the number may be determined according to the practical need. For example, with respect to an 1-hour live stream, the highlight detection unit 1335 may divide the streams into 20 different portions with the length of 3 minutes for each portion, or divide the streams into portions with the length of 5 minutes for each portion.

In some embodiments, the highlight detection unit 1335 may calculate a total score for each portion and rank the total score for each portion to detect the highlight of the stream. More specifically, the highlight detection unit 1335 may determine a threshold total score and detect the portions with total scores above the threshold total score as highlights. As shown in FIG. 19, the stream is divided into 16 portions. The highlight detection unit 1335 may calculate the total score for each portion. In FIG. 19, the user terminal 1210A and user terminal 1210B have made a purchase. The highlight detection unit 1335 may calculate a total score according to the user terminal 1210A and user terminal 1210B. If the user terminal 1210A and the user terminal 1210B have watched the portion, the highlight detection unit 1335 may assign a score to the user terminal 1210A and user terminal 1210B. In some embodiments, the score may be the same or different according to the practical need. In some embodiments, if the user terminal 1210A and user terminal 1210B do not watch the portion, the highlight detection unit 1335 may assign a score of 0 to the user terminal 1210A and user terminal 1210B. In some embodiments, if the user terminal 1210A and user terminal 1210B only watched a percent of the portion, the highlight detection unit 1335 may assign a percent of the score Sa and Sb to the user terminal 1210A and user terminal 1210B respectively.

Referring to FIG. 19, for each portion of the streaming, the user terminal 1210A and 10B may be assigned the scores Sa and Sb respectively. In some embodiments. The total score of each portion may be Sa+Sb. For portion 2, the score Sa may be N and the score Sb may be N, so the total score for portion 2 is 2*N. For portion 6, the score Sa may be N and the score Sb may be 0, so the total score for portion 6 is N. For portion 11, the score Sa may be N and the score Sb may be N/3, because the user terminal 1210B just watched one third of portion 11, so the total score for portion 11 may be (N+N/3). In some embodiments, for each portion of the streaming, a score assigned to a particular user terminal is proportional to the percentage or degree of completion the user terminal has watched that portion. In some embodiments, for each portion of the streaming, the highlights detection unit 35 may assign a weight to each user terminal 1210 according to factors listed in the specification, such as the purchasing data, pre-purchasing data, transaction data, or other relative factors. In other words, the highlights detection unit 35 may assign weights Wa and Wb to the user terminal 1210A and user terminal 1210B, respectively, and calculate the total score for each portion according to the expression of Wa*Sa+Wb*Sb, for example. In some embodiments, the assigned weights may be determined by purchasing or pre-purchasing data of the user terminal. For example, in a particular portion, a user terminal with a higher purchase price may be assigned a higher weight than the weight of another user terminal with a lower purchase price. In some embodiments, the highlights detection unit 35 may rank each portion of the streams according to the total score and detect the portions above a threshold total score as highlights for the streams. For example, the portions with a total score higher than a threshold score may be regarded as highlights, or the portions with top three highest scores may be regarded as highlights or the like. In some embodiments, the threshold score may be determined according to the practical need.

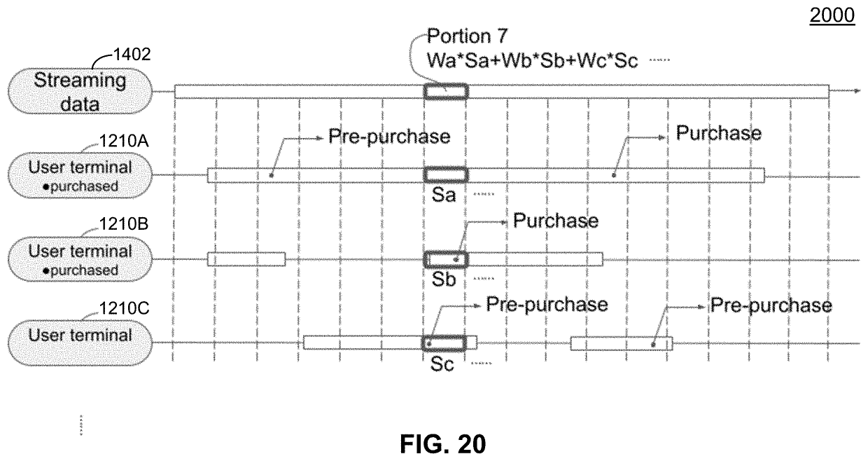

FIG. 20 shows another example 2000 of the highlight detection unit 1335. In FIG. 20, the highlight detection unit 1335 may calculate a total score for each portion according to the pre-purchasing actions and purchasing actions. More specifically, if the user terminals have pre-purchasing actions and purchasing actions, the highlight detection unit 1335 may assign a score to the user terminals. In some embodiments, the score may be the same or different according to the practical need. As shown in FIG. 20, the user terminal 1210A has no pre-purchasing actions or purchasing actions for portion 7, the highlight detection unit 1335 may assign a score of Sa to the user terminal 1210A. The user terminal 1210B has purchasing actions during portion 7, the highlight detection unit 1335 may assign a score of Sb to the user terminal 1210B. The user terminal 1210C has pre-purchasing actions, the highlight detection unit 1335 may assign a score of Sc to the user terminal 1210C for portion 7. In some embodiments, the user terminal 1210A has no pre-purchasing actions and purchasing actions, so the score of Sa may be 0. The total score for portion 7 may be Sa+Sb+Sc. In some embodiments, the highlights detection unit 35 may assign a weight to each user terminal and use the expression of Wa*Sa+Wb*Sb+Wc*Sc to calculate the total score and rank, for example, to detect the highlight portions.

In some embodiments, the highlight detection unit 1335 may calculate a total score for each portion according to the combination of above or the like. As shown in FIG. 20, the user terminal 1210A has watched the portion 7, the highlight detection unit 1335 may assign a score of Sa to the user terminal 1210A according to the action of watching. The user terminal 1210B has watched the portion 7 and performed purchasing actions while watching the portion 7, the highlight detection unit 1335 may assign a score of Sb to the user terminal 1210B according to the actions of watching and purchasing. The user terminal 1210C has watched the portion 7 and performed pre-purchasing actions while watching the portion 7, the highlight detection unit 1335 may assign a score of Sc to the user terminal 1210C according to the actions of watching and pre-purchasing. The total score for the portion 7 may be Sa+Sb+Sc. In some embodiments, the highlights detection unit 35 may weigh different factors to calculate the total score and rank.

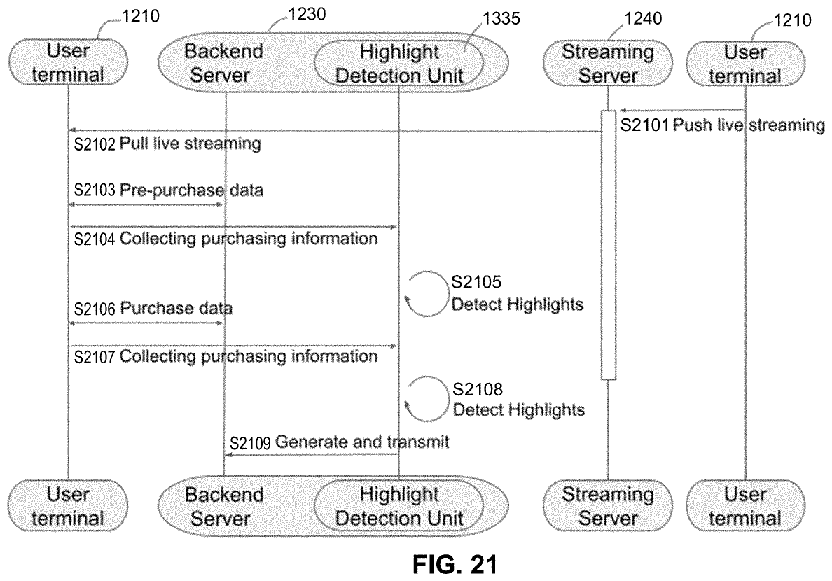

FIG. 21 shows an exemplary sequence chart illustrating an operation of the communication system 1200 and the highlight detection unit 1335. In step S2101, the client application APP in the user terminal 1210 pushes or uploads live streaming data 1402 to the streaming server 1240, in response to an instruction by the user terminal 1210 such as a streamer. Here, the live stream includes streaming data 1402 collected from the microphone and/or the camera. In many cases, the streaming data 1402 includes audio and video contents of the streamer. In some embodiments, the user terminal 1210 here may be referred to as streamer, podcaster or the like.

In step S2102, the client application APP in the user terminal 1210 pulls or downloads the live streaming data 1402 from the streaming server 1240. In some embodiments, the action may include logging in the APP and clicking streamers or online shopping streams to view the live streams. In some embodiments, the user terminal 1210 here may be referred to as viewer, audience, listener or the like.

In step S2103, the user terminal 1210 may perform pre-purchasing actions. In step S2104, the highlight detection unit 1335 collects purchasing information from the user terminal 1210. In some embodiments, the purchasing information may include the pre-purchasing actions the user terminal 1210 performed and the corresponding time information. In some embodiments, the highlight detection unit 1335 may collect the pre-purchasing actions as pre-purchasing data. In some embodiments, the corresponding time information includes the time point or period at which the user terminal 1210 performed the pre-purchasing actions while watching the streams.

In step S2105, the highlight detection unit 1335 may detect highlights of the streams according to the purchasing information. More specifically, the highlight detection unit 1335 may detect highlights of the streams according to the pre-purchasing data and the pre-purchasing actions.

In step S2106, the user terminal 1210 may perform purchasing actions. In step S2107, the highlight detection unit 1335 collects purchasing information from the user terminal 1210. In some embodiments, the purchasing information may include the purchasing actions the user terminal 1210 performed and the corresponding time information. In some embodiments, the purchasing information may include the transaction data of the user terminal 1210. In some embodiments, the highlight detection unit 1335 may collect the purchasing actions as purchasing data. In some embodiments, the corresponding time information includes the time point or period at which the user terminal 1210 performed the purchasing actions while watching the streams.

In step S2108, the highlight detection unit 1335 may detect highlights of the streams according to the purchasing information. More specifically, the highlight detection unit 1335 may detect highlights of the streams according to the purchasing data and purchasing actions.

In step S2109, the highlight detection unit 1335 may generate the highlights and transmit the highlights to the backend server 1230. In some embodiments, the highlight detection unit 1335 may publish the highlights to the user terminal 1210. In some embodiments, the destination to which the highlight detection unit 1335 publishes may be determined according to the practical need.

In some embodiments, the variable of weight, scores and total score may be a default number and may increase or decrease according to the above factors listed in the specification, such as the purchasing data, pre-purchasing data, transaction data, or other relative factors. In some embodiments, actions of a user terminal may be classified as positive, negative or neutral actions. For example, the action of adding/removing from a shopping cart may be referred to as positive/negative actions. Once a positive, negative or neutral action is performed, the variables may be increased by an increment, decreased by a decrement or remain unchanged.

In some embodiments, if the total score of a portion of streaming is higher than a threshold total score, the highlights detection unit 35 may detect the portion as highlights. On the other hand, if the total score is lower than a threshold total score, the highlights detection unit 35 may not detect the portions as highlights. In some embodiments, the increment, decrement and threshold total score may be determined depending on practical needs.

In some embodiments, the highlights detection unit 35 may rank portions of the streams based on the total scores of the portions and detect that portions with total scores higher than a threshold total score are highlights for the streams. For example, the portions with a total score higher than a threshold total score may be regarded as highlights, or the portions with top three highest scores may be regarded as highlights or the like. In some embodiments, the highlight detection unit 1335 may use a machine learning model to optimize the score and weights to calculate the score and the total score.

In some embodiments, the highlight detection unit 1335 may use a variety of factors to calculate the weight, score or total score. In particular embodiments, different factors may be assigned with different weights when calculating the sub-score, score or total score. In some embodiments, the weights for each factor may be static or the weights may change according to, for example, the user terminals, the type of relationship, the type of action, the user terminal's location or time, and so forth. In some embodiments, the highlight detection unit 1335 may consider a variety of factors when determining scores and weights used to calculate the total score. For example, the highlight detection unit 1335 may consider the time since information was accessed, decay factors, frequency of actions, short- or long-term averages of user actions, feedback from user terminals, other suitable factors, or any combination thereof.

In some embodiments, the factors, sub-scores, scores and weights may include a decay factor that causes the strength of the particular data or actions to decay with time, such that more recent data or actions are more relevant when calculating the factors, sub-scores, scores and weights. The factors, sub-score, scores and weights may be continuously updated based on continued tracking of the data or actions. Any type of process or algorithm may be employed for assigning, combining, averaging, and so forth the score for each factor and the weights assigned to the factors and scores. In particular embodiments, the highlight detection unit 1335 may determine factors, sub-scores, scores and weights using machine-learning algorithms trained on historical data, historical actions and past user terminal responses, or data collected from user terminals by exposing them to various options and measuring responses. In some embodiments, the factors, sub-scores, scores and weights may be decided in any suitable manner.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present invention are described above, a person having common knowledge in the technical field of the present invention may still make many variations and modifications without disobeying the teaching and disclosure of the present invention. Therefore, the scope of the present invention is not limited to the embodiments that are already disclosed, but includes another variation and modification that do not disobey the present invention, and is the scope covered by the patent application scope.

### DESCRIPTION OF REFERENCE NUMERALS

1 Communication system
10 User terminal
20 Server
100 Message distribution system
M Message
Mu User message
F 504 Feedback
Freq Frequency
P Preference
110 Collecting unit
120 Evaluating unit
121 Message analysis element
122 Frequency analysis element
123 Relevance analysis element
124 preference evaluating element
1241 criteria calculator
1242 criteria evaluator
1243 criteria module
1244 weighting module
1245 training pairing element
1246 model generator
130 Pushing unit
140 Comparing Unit
600 Communication system
610 User terminal
811 Interaction unit
812 Decoder
813 Display
814 Streaming input
815 Encoder
630 Interaction server
640 Streaming server
700 Data communication system
710 Receiving unit
720 Determining unit
730 Transferring unit
P Communication protocol
A Action
Ai Interaction action
Ani Non-interaction action
1200 Communication system
1210 User terminal
1311 UI unit
1312 Decoder
1313 Display
1314 Streaming input
1315 Encoder
1230 Backend server
1331 Receiving unit
1332 Processing unit
1333 Storage unit
1334 Transmitting unit
1335 Highlight detection unit
1240 Streaming server
1341 Receiving unit
1342 Processing unit
1343 Storage unit
1344 Transmitting unit
1250 Payment system

The present techniques will be better understood with reference to the following enumerated embodiments:

A1. A message distribution system, comprising: a collecting unit, configured to collect feedback on a message from a user terminal; and an evaluating unit, connected to the collecting unit, and configured to evaluate a preference for the message of the user terminal according to the feedback; wherein the feedback includes a response action feedback and/or an influence action feedback, the response action feedback includes an operation to the message by the user terminal, and the influence action feedback includes a behavior followed by the operation.
A2. The message distribution system according to embodiment A1, wherein the evaluating unit further evaluates the preference according to the operation or the behavior.
A3. The message distribution system according to embodiment A1, wherein the feedback further includes a device information, the device information includes an operation time, the operation time is from the message being read to be operated, and the evaluating unit further evaluates the preference according to the device information.
A4. The message distribution system according to embodiment A1, wherein the feedback refers to data transmitted by the user terminal and the evaluating unit evaluates the preference P for the message M according to different types of the data.
A5. The message distribution system according to embodiment A4, wherein the behavior comprises at least one or more of the following: being idle, searching, visiting, following, purchasing, sending, watching, commenting, supporting, marking, collecting, claiming and so on.
A6. The message distribution system according to embodiment A4, wherein the feedback further includes a time information and/or a location information, the evaluating unit further evaluates the preference according to the time information and/or the location information.
A7. The message distribution system according to embodiment A4, wherein the evaluating unit comprises a message analysis element, the message analysis element is configured to analyze a user message left by the user terminal, and the evaluating unit evaluates the preference according to the user message.
A8. The message distribution system according to embodiment A4, wherein the evaluating unit comprises a frequency analysis element, the frequency analysis element is configured to analyze a frequency of the feedback on the message, and the evaluating unit evaluates the preference according to the frequency.
A9. The message distribution system according to embodiment A4, wherein the evaluating unit comprises a relevance analysis element, the relevance analysis element is configured to identify the relevance between the message and the feedback, and the evaluating unit evaluates the preference according to the relevance.
A10. The message distribution system according to embodiment A1, further comprising a pushing unit, wherein the pushing unit is connected to the evaluating unit, and configured to push the message to the user terminal if the user terminal has the preference for the message.
A11. The message distribution system according to embodiment A1, further comprising a preference evaluating element, the preference evaluating element being evaluating the preference according to at least one or more of the following: the retention rate of the user terminal, click rate of the message, unsubscribe rate of the message, session length on opening an APP and getting involved in the APP through the message, frequency of opening the APP or the like.
A12. The message distribution system according to embodiment A1, wherein the collecting unit and the evaluating unit collect the feedback and evaluate the preference dynamically, and the feedback includes historical feedback and real-time feedback.
A13. The message distribution system according to embodiment A1, further comprising a comparing unit, the comparing element being connected to the collecting unit and the evaluating unit respectively, and configured to compare the feedback from different user terminals and classify the user terminals into groups.
A14. The message distribution system according to embodiment A1, wherein the message is a push notification, and the contents of the message is related to live streaming.
A15. A message distribution method, comprising: collecting feedback on a message from a user terminal; and evaluating a preference for the message of the user terminal according to the feedback; wherein the feedback includes a response action feedback and an influence action feedback, the response action feedback includes an operation to the message by the user terminal, and the influence action feedback includes a behavior followed by the operation.
A16. The message distribution method according to embodiment A15, further comprising analyzing a user message left by the user terminal, and the preference being evaluated according to the user message.
A17. The message distribution method according to embodiment A15, further comprising analyzing frequency of the feedback on the message, and the preference being evaluated according to the frequency.
A18. The message distribution method according to embodiment A15, further comprising identifying a relevance between the message and the feedback, and the preference being evaluated according to the relevance.
A19. The message distribution method according to embodiment A15, further comprising pushing the message to the user terminal if the user terminal has the preference for the message.
A20. The message distribution method according to embodiment A15, wherein the message is a push notification, and the contents of the message is related to live streaming.
B1. A data communication system, comprising: a receiving unit, configured to receive an action performed by an user terminal; and a determining unit, connected to the receiving unit and configured to determine a communication protocol toward the user terminal according to the action; wherein the communication protocol is transferred to the user terminal for the user terminal to request real-time data via the communication protocol.
B2. The data communication system according to embodiment B1, wherein the receiving unit further receives available communication protocols mutually applicable to the user terminal and the server, and the determining unit selects the communication protocol from the available communication protocols and further determines the communication protocol according to the action.
B3. The data communication system according to embodiment B1, wherein the determining unit further includes a predicting element, the predicting element is configured to predict a following action according to the action, the determining unit determines the communication protocol according to the following action.
B4. The data communication system according to embodiment B3, wherein the predicting element collects a plurality of historical data from the user terminal to predict the following action.
B5. The data communication system according to embodiment B1, wherein the action further includes an interaction action, the interaction action transmits and/or receives interaction data, or transmits and receives streaming data, and the determining unit determines the communication protocol according to the interaction action.
B6. The data communication system according to embodiment B1, wherein the action further includes a non-interaction action, the non-interaction action receives without transmitting streaming data or transmits without receiving streaming data, and the determining unit determines the communication protocol according to the non-interaction action.
B7. The data communication system according to embodiment B1, wherein the determining unit determines the communication protocol for the user terminal to receive the streaming data with audio contents only.
B8. The data communication system according to embodiment B1, wherein the determining unit determines the communication protocol for the user terminal to receive the streaming data with video contents only.
B9. The data communication system according to embodiment B1, wherein the determining unit determines the communication protocol for the user terminal to transmit the streaming data with audio contents and/or video contents.
B10. The data communication system according to embodiment B1, wherein the determining unit determines the communication protocol for the user terminal to receive or transmit the interaction data.
B11. The data communication system according to embodiment B1, wherein the determining unit determines the communication protocol for the user terminal to receive and transmit the interaction data.
B12. The data communication system according to embodiment B1, wherein the determining unit determines the communication protocol for the user terminal to receive streaming data from different user terminals continuously in a short time.
B13. The data communication system according to embodiment B1, wherein the determining unit determines the communication protocol for the user terminal to receive streaming data from different user terminals concurrently.
B14. The data communication system according to embodiment B1, further comprising a feedback collecting unit, the feedback collecting unit being collecting feedback from the user terminal and transmitting the feedback to the determining unit; wherein the determining unit determines the communication protocol according to the feedback.
B15. The data communication system according to embodiment B1, the determining unit determines the communication protocol according to an internet quality, the internet quality is evaluated by indexes of first render, video latency, buffering ratio or buffering count.
B16. A data communication method, comprising: receiving an action performed by an user terminal; and determining a communication protocol toward the user terminal according to the action; wherein the communication protocol is transferred to the user terminal for the user terminal to request real-time data via the communication protocol.
B17. The data communication method according to embodiment B16, wherein the action further includes an interaction action, the interaction action transmits and/or receives interaction data, or transmits and receives streaming data, and the determining unit determines the communication protocol according to the interaction action.
B18. The data communication method according to embodiment B16, wherein the action further includes a non-interaction action, the non-interaction action receives without transmitting streaming data or transmits without receiving streaming data, and the determining unit determines the communication protocol according to the non-interaction action.
B19. The data communication method according to embodiment B16, wherein the determining unit determines the communication protocol for the user terminal to receive streaming data from different user terminals continuously in a short time.
B20. The data communication method according to embodiment B16, wherein the determining unit determines the communication protocol for the user terminal to receive streaming data from different user terminals concurrently.
C1. A highlight detection method for detecting highlight of a stream, comprising: collecting purchasing information from a user terminal; and detecting the highlight of the stream according to the purchasing information; wherein the purchasing information includes purchasing actions of the user terminal, and the purchasing actions are actions related to purchase of the user terminal.
C2. The highlight detection method according to embodiment C1, wherein the purchasing actions include actions such as clicking buy button, establishing an order, or finishing payment.
C3. The highlight detection method according to embodiment C1, wherein the purchasing information includes corresponding time information of portions of the stream the user terminal watched.
C4. The highlight detection method according to embodiment C3, further comprising: checking the user terminal's payment status; selecting the user terminal who has payment record; capturing the portions of the stream the user terminal watched; and detecting the portions of the stream as highlights of the stream.
C5. The highlight detection method according to embodiment C3, further comprising: collecting purchasing information from plural user terminals, checking the user terminals' payment status; selecting the user terminals who have payment record; comparing the portions of the stream the user terminals watched; and capturing overlapped portions the user terminals watched; detecting the overlapped portions as highlights of the streams.
C6. The highlight detection method according to embodiment C1, wherein the purchasing information includes pre-purchasing actions and the pre-purchasing actions are actions that show a willingness of the user terminal to make a purchase.
C7. The highlight detection method according to embodiment C6, wherein the pre-purchasing actions include actions such as enlarging a picture of a product, checking a description of a product, adding a product to wishlist, adding a product to favorite, adding a product to shopping cart, or checking available coupons, discount tickets, gift certificates.
C8. The highlight detection method according to embodiment C6, further comprising: detecting the highlight according to a time point of a purchasing action or pre-purchasing action the user terminal performed.
C9. The highlight detection method according to embodiment C1, wherein the stream is related to live streaming such as entertainment shows or online shopping.
C10. The highlight detection method according to embodiment C8, further comprising: setting a time range with respect to the time point, capturing portions of the stream according to the time point and the time range, detecting the portions of the stream as highlights.
C11. The highlight detection method according to embodiment C8, further comprising: setting a time offset for the time point, offsetting the time point to an offset time point, capturing portions of the stream according to the offset time point, detecting the portions of the stream as highlights.
C12. The highlight detection method according to embodiment C5, further comprising: calculating total scores for each portion, and detecting the highlights according to the total scores; wherein the total score is a sum of each score from the user terminal, and the scores are decided according to the purchasing information.
C13. The highlight detection method according to embodiment C5, further comprising: calculating total scores for each portion, and detecting the highlights according to the total scores; wherein the total score is a weighted sum of each score from the user terminal, the scores are decided according to the purchasing action and pre-purchasing action of the user terminal, and the weights are decided according to transaction data of the user terminal.
C14. The highlight detection method according to embodiment C1, further comprising: dividing the streams into different portions, calculating total scores for each portion, detecting the highlights according to the total scores.
C15. The highlight detection method according to embodiment C14, further comprising: ranking the portions of the stream based on the total score detecting the portions above a threshold total score as highlights.
C16. A system for detecting highlight of a stream, comprising a highlight detection unit configured to perform: collecting purchasing information from a user terminal, and detecting the highlight of the stream according to the purchasing information; wherein the purchasing information includes purchasing actions of the user terminal, and the purchasing actions are actions related to purchase of the user terminal.
C17. The system according to embodiment C16, wherein the purchasing actions include actions such as clicking buy button, establishing an order, or finishing payment.
C18. The system according to embodiment C16, wherein the highlight detection unit is further configured to perform: checking the user terminal's payment status; selecting the user terminal who has payment record; capturing the portions of the stream the user terminal watched; and detecting the portions of the stream as highlights of the stream.
C19. The highlight detection system according to embodiment C16, wherein the highlight detection unit is further configured to perform: calculating total scores for each portion, and detecting the highlights according to the total scores; wherein the total score is a weighted sum of each score from the user terminal, the scores are decided according to the purchasing action and pre-purchasing action of the user terminal, and the weights are decided according to transaction data of the user terminal.
C20. A non-transitory computer-readable medium storing instructions that, when executed by one or more processors, cause the one or more processors to perform: collecting purchasing information from a user terminal; and detecting the highlight of the stream according to the purchasing information; wherein the purchasing information includes purchasing actions of the user terminal, and the purchasing actions are actions related to purchase of the user terminal.

What is claimed is:

1. A method for detecting a highlight of a stream, comprising:
collecting purchasing information from a user terminal; and
detecting a highlight of a stream based on the purchasing information, wherein the purchasing information includes purchasing actions of the user terminal, and the purchasing actions relate to a purchase of the user terminal.

2. The method according to claim 1, wherein the purchasing actions include actions such as clicking buy button, establishing an order, or finishing payment.

3. The method according to claim 1, wherein the purchasing information includes corresponding time information of portions of the stream the user terminal watched.

4. The method according to claim 3, further comprising:
checking a payment status of the user terminal;
selecting the user terminal who has payment record;
capturing the portions of the stream the user terminal watched; and
detecting the portions of the stream as highlights of the stream.

5. The method according to claim 3, further comprising:
collecting purchasing information from plural user terminals,
checking a payment status of the user terminals;
selecting the user terminals who have payment record;
comparing the portions of the stream the user terminals watched;
capturing overlapped portions the user terminals watched; and
detecting the overlapped portions as highlights of the streams.

6. The method according to claim 1, wherein the purchasing information includes pre-purchasing actions and the pre-purchasing actions are actions that show a willingness of the user terminal to make a purchase.

7. The method according to claim 6, wherein the pre-purchasing actions include actions such as enlarging a picture of a product, checking a description of a product, adding a product to wishlist, adding a product to favorite, adding a product to shopping cart, or checking available coupons, discount tickets, gift certificates.

8. The method according to claim 6, further comprising:
detecting the highlight according to a time point of a purchasing action or pre-purchasing action the user terminal performed.

9. The method according to claim 1, wherein the stream is related to live streaming such as entertainment shows or online shopping.

10. The method according to claim 8, further comprising:
setting a time range with respect to the time point;
capturing portions of the stream according to the time point and the time range; and
detecting the portions of the stream as highlights.

11. The method according to claim 8, further comprising:
setting a time offset for the time point;
offsetting the time point to an offset time point;
capturing portions of the stream according to the offset time point; and
detecting the portions of the stream as highlights.

12. The method according to claim 5, further comprising:
calculating total scores for each portion; and
detecting the highlights according to the total scores, wherein the total score is a sum of each score from the user terminal, and the scores are decided according to the purchasing information.

13. The method according to claim 5, further comprising:
calculating total scores for each portion; and
detecting the highlights according to the total scores, wherein the total score is a weighted sum of each score from the user terminal, the scores are decided according to the purchasing action and pre-purchasing action of the user terminal, and the weights are decided according to transaction data of the user terminal.

14. The method according to claim 1, further comprising:
dividing the streams into different portions;
calculating total scores for each portion; and
detecting the highlights according to the total scores.

15. The method according to claim 14, further comprising:
ranking the portions of the stream based on the total score; and
detecting the portions above a threshold total score as highlights.

16. The method of claim 1, wherein the streaming comprises live streaming, and wherein feedback is collected on a message from the user terminal, the message including content related to the live streaming.

17. The method of claim 16, wherein the feedback includes an influence action feedback, the influence action feedback comprising a behavior, and the behavior comprising the purchase of the user terminal.

18. The method of claim 16, wherein the feedback is provided to a feedback collecting unit, the feedback collecting unit being provided to a determining unit to determine a communication protocol according to the feedback.

19. The method of claim 1, wherein the user terminal comprises a determining unit, the determining unit being configured to determine a communication protocol for the user terminal to receive streaming data comprising the streaming.

20. A system for detecting highlight of a stream, comprising a highlight detection unit configured to perform:
collecting purchasing information from a user terminal; and
detecting the highlight of the stream according to the purchasing information; wherein the purchasing information includes purchasing actions of the user terminal, and the purchasing actions are actions related to purchase of the user terminal.

21. The system according to claim 20, wherein the purchasing actions include actions such as clicking buy button, establishing an order, or finishing payment.

22. The system according to claim 20, wherein the highlight detection unit is further configured to perform:
checking a payment status of the user terminal;
selecting the user terminal who has payment record;
capturing portions of the stream the user terminal watched; and
detecting the portions of the stream as highlights of the stream.

23. The highlight detection system according to claim 20, wherein the highlight detection unit is further configured to perform:
calculating total scores for each portion; and
detecting the highlights according to the total scores, wherein the total score is a weighted sum of each score from the user terminal, the scores are decided according to the purchasing action and pre-purchasing action of the user terminal, and the weights are decided according to transaction data of the user terminal.

24. A non-transitory computer-readable medium storing instructions that, when executed by one or more processors, cause the one or more processors to perform:
collecting purchasing information from a user terminal; and
detecting a highlight of a stream according to the purchasing information; wherein the purchasing information includes purchasing actions of the user terminal, and the purchasing actions are actions related to purchase of the user terminal.
